(19) United States
(12) Patent Application Publication
(10) Pub. No.: US 2026/0093966 A1
(43) Pub. Date: Apr. 2, 2026

(54) PRE-COMPUTATION-BASED IMPLEMENTATION OF NEURAL NETWORKS

(71) Applicant: University of Florida Research Foundation, Incorporated, Gainesville, FL (US)

(72) Inventors: Swarup Bhunia, Gainesville, FL (US); Baibhab Chatterjee, Gainesville, FL (US); Atri Chatterjee, Gainesville, FL (US); Habibur Rahaman, Gainesville, FL (US)

(21) Appl. No.: 19/316,443

(22) Filed: Sep. 2, 2025

Related U.S. Application Data
(60) Provisional application No. 63/701,631, filed on Oct. 1, 2024.

(51) Int. Cl. G06N 3/0495; G06N 3/044; G06N 3/0464

(52) U.S. Cl. CPC G06N 3/0495; G06N 3/0464; G06N 3/044

(57) ABSTRACT

A system comprising a pre-compute storage memory comprising a plurality of pre-computed results that correspond to a neural network operation during inferencing or training, wherein the pre-compute storage memory is configured to provide the plurality of pre-computed results as output that is used in determining an activation of a next layer in a neural network; a memory array configured to store a plurality of weight activation sets; an address decoder configured to (i) generate an address in the pre-compute storage memory that matches an input operand, wherein the address corresponds to a weight activation set of the plurality of weight activation sets that matches the input operand and (ii) fetch a pre-computed result of the plurality of pre-compute results from the pre-compute storage memory based on the address.

### CROSS REFERENCE TO RELATED APPLICATION

This application claims the priority of U.S. Provisional Application No. 63/701,631, entitled “PRE-COMPUTATION-BASED IMPLEMENTATION OF NEURAL NETWORKS,” filed on Oct. 1, 2024, the disclosure of which is hereby incorporated by reference in its entirety.

### BACKGROUND

Neural networks deployed in areas, such as data centers, edge devices, etc., may require energy-efficient computing paradigms. Edge devices, such as mobile phones, drones, and wearable devices, may perform on-device training and deployment of neural networks for environmental adaptation, which may benefit model customization and data privacy protection. However, many edge devices rely on batteries or have energy constraints. Thus, there is a need for energy-efficient implementation of neural networks on various hardware platforms, especially during training and inference phases.

### BRIEF SUMMARY

Various embodiments described herein relate to methods, apparatus, systems, computing devices, computing entities, and/or the like for implementing energy and computationally efficient neural networks.

According to some embodiments, a system comprises a pre-compute storage memory comprising a plurality of pre-computed results that correspond to a neural network operation during inferencing or training, wherein the pre-compute storage memory is configured to provide the plurality of pre-computed results as output that is used in determining an activation of a next layer in a neural network; a memory array configured to store a plurality of weight activation sets; an address decoder configured to (i) generate an address in the pre-compute storage memory that matches an input operand, wherein the address corresponds to a weight activation set of the plurality of weight activation sets that matches the input operand and (ii) fetch a pre-computed result of the plurality of pre-compute results from the pre-compute storage memory based on the address.

In some embodiments, the memory array comprises (i) an activation memory configured to store one or more high-frequency input activations corresponding to the plurality of weight activation sets and (ii) a weight memory configured to store one or more weights corresponding to the one or more high-frequency input activations. In some embodiments, the pre-compute storage memory comprises a content-addressable memory (CAM), a static random-access memory (SRAM), or a lookup table (LUT)-based structure.

According to some embodiments, an apparatus comprising a plurality of pre-computation-based energy-efficient neural network (PENN) neurons, wherein a PENN neuron comprises a multiply-accumulate (MAC) unit, a neuron finite state machine (FSM), and a neuron pre-compute storage memory; a cluster computational unit configured to compute values for the plurality of PENN neurons; a layer pre-compute storage memory configured to store a plurality of pre-computed results of a plurality of neural network operations; and a layer FSM configured to utilize the plurality of pre-computed results during the plurality of neural network operations.

In some embodiments, the neuron pre-compute storage memory or the layer pre-compute storage memory comprises a content-addressable memory (CAM), a static random-access memory (SRAM), or a lookup table (LUT). In some embodiments, the neuron pre-compute storage memory or the layer pre-compute storage memory is configured to store a plurality of pre-computed multiplication results for frequently occurring input patterns. In some embodiments, the neuron FSM is configured to retrieve the pre-computed multiplication results from the neuron pre-compute storage memory to bypass multiplication operations during neural network computations.

According to some embodiments, a method comprises receiving input data for a neural network operation on a neural network; determining a pre-computed result corresponding to the input data is stored in a pre-compute storage memory; retrieving the pre-computed result from the pre-compute storage memory; and performing the neural network operation using the retrieved pre-computed result.

In some embodiments, the pre-compute storage memory comprises a content-addressable memory (CAM), a static random-access memory (SRAM), or a lookup table (LUT). In some embodiments, the pre-computed result comprises a multiplication result for a frequently occurring input pattern corresponding to the neural network operation. In some embodiments, the method further comprises applying a pruning technique or a quantization technique to optimize the neural network operation. In some embodiments, the pruning technique comprises removing a weight or an activation with low magnitude comprising minimal impact on performance of the neural network. In some embodiments, the quantization technique comprises discretizing a range of weight or activation values that reduces bit representation of the range of weight or activation values. In some embodiments, the method further comprises dynamically reconfiguring a smallest unit of data in the pre-compute storage memory. In some embodiments, the method further comprises generating a frequency distribution of a plurality of operand pairs for a plurality of neural network operations; and storing a set of one or more most frequently occurring operand pairs and a set of corresponding multiplication results in the pre-compute storage memory. In some embodiments, (i) the neural network comprises a convolutional neural network (CNN) and (ii) the pre-computed result comprises a multiplication result for an input feature map and a filter weight. In some embodiments, (i) the neural network comprises a recurrent neural network (RNN) and (ii) the pre-computed result comprises a multiplication result for a hidden state and a recurrent weight. In some embodiments, the method further comprises upscaling a data unit from the pre-compute storage memory to a byte-addressable format associated with communication with an external device.

### BRIEF DESCRIPTION OF THE DRAWINGS

Embodiments incorporating teachings of the present disclosure are shown and described with respect to the figures presented herein.

FIG. 1 depicts an example neural network.

FIG. 2 is a schematic of an example field-programmable gate array (FPGA) implementation of a neural network.

FIG. 3 is a schematic of an example graphics processing unit (GPU) implementation of a neural network.

FIG. 4A and FIG. 4B are example circuit diagrams for implementing neural networks.

FIG. 5A is a diagram of an example PENN neuron cluster in accordance with some embodiments of the present disclosure.

FIG. 5B is a block diagram of an example system architecture of a PENN neural network framework at the hardware level.

FIG. 6 is a diagram of an example LUT configuration in accordance with some embodiments of the present disclosure.

FIG. 7 is a diagram of an example SRAM configuration in accordance with some embodiments of the present disclosure.

FIG. 8A depicts resource sharing in an example SRAM-based implementation in accordance with some embodiments of the present disclosure.

FIG. 8B depicts an example SRAM array in accordance with some embodiments of the present disclosure.

FIG. 9 is a diagram of an example CAM-based PENN in accordance with some embodiments of the present disclosure.

FIG. 10 is a flowchart of an example PENN software design process in accordance with some embodiments of the present disclosure.

FIG. 11 depicts example parameters for generating and optimizing a machine learning mode in accordance with some embodiments of the present disclosure.

FIG. 12 is a flowchart of an example CAM-based PENN software implementation process 1200 in accordance with some embodiments of the present disclosure.

FIG. 13 is a diagram of an example CAM pre-compute block in accordance with some embodiments of the present disclosure.

FIG. 14 is a flowchart diagram of an example software implementation process for a LUT/SRAM-based PENN in accordance with some embodiments of the present disclosure.

FIG. 15A and FIG. 15B are example schematic diagrams of a LUT-based PENN and a SRAM-based PENN, respectively, in accordance with some embodiments of the present disclosure.

FIG. 16A depicts an example integer-only quantization in accordance with some embodiments of the present disclosure.

FIG. 16B depicts an example simulated quantization in accordance with some embodiments of the present disclosure.

FIG. 16C depicts an example full-precision quantization in accordance with some embodiments of the present disclosure.

FIG. 17 depicts an example conversion of FP32 to INT 6-bit in accordance with some embodiments of the present disclosure.

FIG. 18 depicts a flow diagram of example pruning-quantization in accordance with some embodiments of the present disclosure.

FIG. 19 is a flowchart of an example hardware design process in accordance with some embodiments of the present disclosure.

FIG. 20 is an example PENN accelerator in accordance with some embodiments of the present disclosure.

FIG. 21 is a schematic of an example CAM-based PENN neuron in accordance with some embodiments of the present disclosure.

FIG. 22 is a schematic of an example CAM-based PENN layer based on a CAM implementation in accordance with some embodiments of the present disclosure.

FIG. 23 is a schematic of an example CAM-based PENN neural network based on a CAM implementation in accordance with some embodiments of the present disclosure.

FIG. 24 is a schematic of an example associative memoryless PENN neuron in accordance with some embodiments of the present disclosure.

FIG. 25 is a schematic of an example LUT-based PENN neuron based on a LUT implementation in accordance with some embodiments of the present disclosure.

FIG. 26 is a schematic of an example SRAM-based PENN layer in accordance with some embodiments of the present disclosure.

FIG. 27 is a schematic of an example SRAM-based PENN neural network in accordance with some embodiments of the present disclosure.

FIG. 28 is a flowchart of an example global PENN state transition process in accordance with some embodiments of the present disclosure.

FIG. 29 is a flowchart of an example PENN layer state machine state transition process in accordance with some embodiments of the present disclosure.

FIG. 30 is a flowchart of an example PENN neuron state machine state transition process in accordance with some embodiments of the present disclosure.

### DETAILED DESCRIPTION

Various embodiments of the present disclosure will now be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

Data processed remotely by data centers for edge devices may lead to communication delays, affecting real-time applications. A possible solution may comprise embedding neural network mechanisms at the edge to handle some computational tasks. However, such a solution may demand significant memory and computational resources not typically available in embedded devices.

The effectiveness of a deep neural network (DNN) may come with a significant demand for energy and computational resources, especially during training and inference, as complex computations in a DNN may handle millions of parameters and hundreds of hidden layers, leading to time-consuming processes and high energy consumption. For example, a fully connected neural network comprising n neurons in each layer, and L layers. The number of multiplications for one epoch during a feedforward operation may be n²×L. If a neural network has 100 layers and 1000 neurons in each layer, then the number of multiplications performed by a multiply-accumulate (MAC) unit for one epoch during forward pass may be (1000×1000×100) or 108, thereby resulting in excessive energy consumption and increased time complexity, and even so for several epochs. In another example, convolutional neural network (CNN) architectures, such as VGG16 with 13 convolutional layers and 3 fully connected layers (e.g., first fully connected layer with 4096 neurons, second fully connected layer with 4096 neurons, and output layers containing 1000 neurons) may demand 2.84 billion multiplications.

The large requirement of energy and computational resources in DNNs, especially during training and inference due to millions of parameters and complex computations, makes DNNs challenging to deploy in energy-limited environments, such as in mobile devices and/or embedded systems. To meet the increased demand for complex neural networks, the present disclosure provides innovative techniques and/or solutions for reducing computational complexity and energy consumption in neural network implementations.

The present disclosure provides techniques for achieving energy and computation-efficient memory-centric implementation of DNNs via pre-compute reuse of neural network operations. Additionally, memory-centric computing utilizing lookup tables (LUTs) and recurrent data patterns may address complex computations of neural networks, thereby speeding up processing. Some embodiments of the present disclosure may provide enhanced computationally cost-aware neural network training and inferencing at the software-hardware level by utilizing a content-addressable memory (CAM)/static random-access memory (SRAM)/LUT-based structure for storing intermediate activations and weights.

According to various embodiments of the present disclosure, a pre-computation-based energy-efficient neural network (PENN) framework may address the challenges of achieving energy-efficient computations of neural networks in resource-constrained environments without sacrificing performance. In some embodiments, a PENN framework may provide energy efficient computation by adopting computational reuse in neural network inference and/or training. In some embodiments, a PENN framework comprises a pre-compute storage memory (e.g., CAM/SRAM/LUT array) that is configured to facilitate pre-computation at various stages of neural network operation during inferencing and training phases. In some embodiments, a PENN framework provides lookup-based computation in neural networks that leverages pre-computed results as well as hardware reuse in both inferencing and training phases, while lookup may be performed using LUTs, SRAM, CAM, or a combination thereof. In some embodiments, various properties, such as data sparsity, skewed frequency, resource sharing, constant input, regularity in architecture to achieve optimized energy efficiency, or overall performance in neural network hardware, may be used to perform lookup-based computations.

In some embodiments, a software-hardware co-design approach may be used to implement a PENN. At the software design phase, an architecture comprising a deep neural network model with different parameters may be developed and optimized using pruning and quantization techniques, resulting in substantial optimization for energy efficient computation. After optimization, pre-compute values may be stored in a LUT/CAM/SRAM table for computational reuse. During a hardware design phase, a parser tool may be configured to parse a deep neural network (DNN) model that is developed via the software design phase and generate an abstract syntax tree (AST) data structure, which may be optimized using pruning and quantization techniques. The AST data structure may comprise SRAM/CAM modules that are linked to PENN primitive nodes.

In some embodiments, a software aspect of the PENN framework may comprise (i) determining an architectural design of a DNN (e.g., the number of neurons per layer, total (number of) layers, connectivity, and feature extraction protocol) and (ii) applying pruning and quantization optimization techniques to optimize for energy and computation efficiency. For further optimization, selective quantization may be performed. In some embodiments, after optimization, most frequently encountered activations and weight pairs may be stored in CAM and resultant multiplication may be saved in a block memory for computational reuse. In some example embodiments, a LUT/SRAM array may be configured to store optimized computational results to skip or avoid performance of MAC operations, thereby resulting in energy efficiency.

In some embodiments, a hardware aspect of the PENN framework may comprise parsing a DNN, determined at the software design phase, by using a parser, such as Open Neural Network Exchange (ONNX), and creating an AST data structure. The AST data structure may be optimized using pruning and quantization techniques to provide further enhancement of energy and computation efficiency. The PENN framework may support both on-device training and inferencing. For inferencing, weights and biases (i) may be received from a software model and (ii) associated with nodes of the AST data structure by the PENN framework. In some embodiments, control and data flow of finite-state machines (FSMs) that are associated with PENN primitives are generated. In some embodiments, SRAM/CAM modules are linked to PENN primitive nodes in the AST data structure, followed by generating application-specific PENN register-transfer level (RTL) and configuration bitstreams.

In some embodiments, a PENN may support both on-device training and inferencing. According to various embodiments of the present disclosure, a PENN may significantly reduce energy consumption and computational complexity of neural network models without loss of accuracy levels. Accordingly, a PENN may facilitate the deployment of optimized complex DNN models in energy-constrained and computation-limited environments, thereby enabling artificial intelligence (AI) applications in real-world scenarios. In some embodiments, the PENN framework further comprises a verification setup that is used to confirm correctness of application-specific PENN RTLs before synthesis and/or fabrication. Once fabricated, a PENN accelerator may be created based on user specifications for on-device inference, training, or both, with weights and biases assigned accordingly. Accordingly, by leveraging pre-compute storage memory, the disclosed PENN framework may enhance energy efficiency and reduce processing time across neural network models.

The following provides example benefits of the disclosed PENN framework.

1. Energy and Computational Efficiency: By using CAM or SRAM for inferencing and training, PENN may reduce neural network computational load, making inferencing and training more energy-efficient.

2. Accelerated Neural Network Operations: As weights, activations, and inputs are pruned and quantized, utilization of hardware (e.g., field-programmable gate arrays (FPGAs) units), such as multipliers and adders, may be improved (e.g., reduced) to provide faster training and inferencing.

3. Hybrid Computing Models with Cloud and Edge Integration: In some embodiments, the disclosed PENN framework may provide hybrid computing models that integrate both cloud and edge resources to optimize energy efficiency. For example, computations that are energy-intensive but not time-sensitive may be offloaded to the cloud, while time-sensitive tasks are handled locally on edge devices using the PENN framework. Such a hybrid approach may facilitate energy usage that is distributed optimally across available resources, leveraging the strengths of both cloud and edge computing.

4. Energy-Aware Training Algorithms: In some embodiments, the disclosed PENN framework may comprise training algorithms that are energy-aware via incorporation of CAM/SRAM used for storing intermediate results and frequently-accessed patterns. By integrating energy consumption metrics directly into a training process, the disclosed PENN framework may prioritize computations that are more energy-efficient and defer or batch less critical operations, thereby reducing immediate energy footprint and allowing the training process to remain sustainable over longer periods.

5. Broader Applicability and Sustainability: The disclosed PENN framework may provide advanced neural network models that are viable in energy-constrained computation, which may help with environment adaption of edge devices, such as mobile devices and embedded systems, and reduce environmental impact of computing technologies, aligning with sustainable practices in the AI field.

6. Energy-Efficient Mixed-Precision Neural Networks: The disclosed PENN framework may provide mixed-precision DNNs for achieving energy efficiency, such as in resource-constrained environments, with optimized accuracy. Mixed-precision DNNs may determine the optimal bit precision for each layer to preserve accuracy.

7. Reduced Latency: By performing an entirety of training on edge devices, latency may be reduced.

8. Low-Bit Precision Training or Inferencing: The disclosed PENN framework may provide training and inference with low-bit and mixed precision, thereby reducing total model size.

9. Low-Power Training or Inferencing: Via efficient utilization of MAC units as a result of high compute parallelism, low power training or inferencing may be provided.

10. Adaptive Precision Scaling Based on Computational Context: The disclosed PENN framework may provide an adaptive precision scaling methodology that adjusts bit precision of computations dynamically based on the complexity and specifications of a current task. For example, high-precision calculations may be reserved for critical tasks or final layers of a neural network, while earlier layers or less critical operations may utilize lower precision. Selective precision scaling may reduce computational overhead and energy consumption without compromising overall model accuracy.

11. Lower Overhead DNN Accelerator: The disclosed PENN framework may provide a customizable, low-power, less memory-footprinted accelerator. Inferencing and training may be performed by leveraging PENN optimization techniques that take advantage of MAC units and fabrics.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may specify conversion into executable machine code by an assembler prior to execution by the hardware architecture and/or platform. Another example programming language may be a higher-level programming language that may be portable across multiple architectures. A software component comprising higher-level programming language instructions may specify conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable storage media (including volatile and non-volatile media).

A non-volatile computer-readable storage medium may include one or more magnetic and/or electro-mechanical storage devices, such as floppy disk(s), hard disk(s), magnetic tape, punch card(s), paper tape(s), optical mark sheet(s) (or any other physical medium with patterns of holes or other optically or mechanically detectable indicia), any other non-transitory magnetic medium, and/or the like. A non-volatile computer-readable storage medium may additionally or alternatively include one or more optical storage devices, such as compact disc read only memory (CD-ROM), compact disc-rewritable (CD-RW), any other non-transitory optical medium, and/or the like. A non-volatile computer-readable storage medium may additionally or alternatively include one or more read-only memory (ROM); programmable read-only memory (PROM); erasable programmable read-only memory (EPROM); electrically erasable programmable read-only memory (EEPROM), such as flash memory; and/or the like. In some examples, flash memory may comprise a set of field effect transistors and/or other devices or circuitry that implement serial and/or parallel NAND, NOR, and/or other hardware logic for storing data. In some examples, solid state storage (SSS), such as a solid state drive (SSD), flash drive, solid-state hybrid drives (SSHDs), and/or the like may include flash memory (SSHDs are a hybrid device that may include a hard disk and flash memory in some examples); and, in some examples, flash memory may be used as cache memory, implemented as a basic input output system (BIOS) chip or part of a BIOS chip, and/or the like. A non-volatile computer-readable storage medium may additionally or alternatively include 3D XPoint memory, non-volatile random access memory (NVRAM) (e.g., bridging random access memory (CBRAM), phase-change random access memory (PRAM), magnetoresistive random-access memory (MRAM), ferroelectric random-access memory (FeRAM)), racetrack memory, and/or the like. A non-volatile computer-readable storage medium may additionally or alternatively include one or more thermo-mechanical storage devices, such as Millipede memory; one or more molecular memory repositories; and/or the like.

A volatile computer-readable storage medium may include random access memory (RAM), dynamic random access memory (DRAM), static random access memory (SRAM), synchronous dynamic random access memory (SDRAM), cache memory (including various levels), register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example Neural Network Architecture

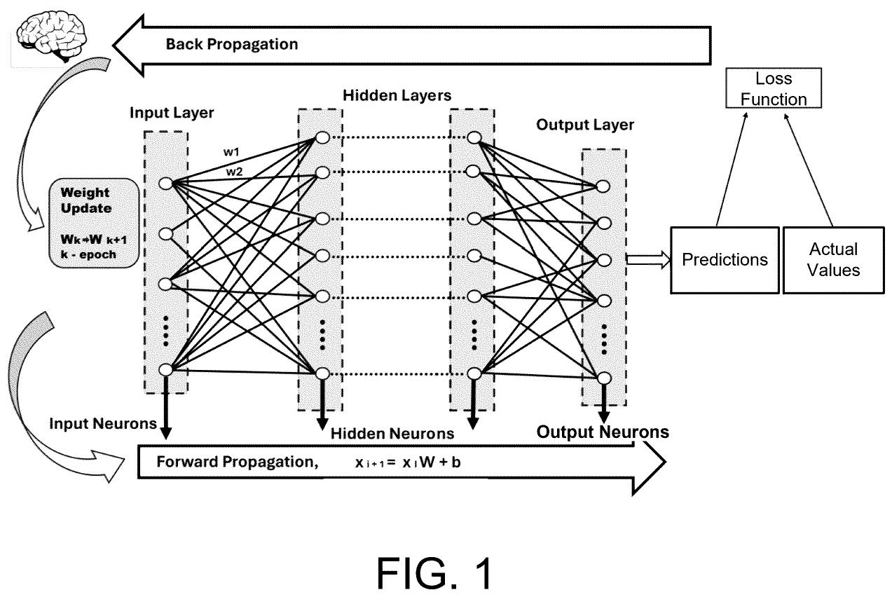

FIG. 1 depicts an example neural network. A neural network may perform different energy-intensive computations in a learning (e.g., training) process that maps input data to desired output which may involve, for example, forward propagation, error calculation, and backward propagation, including fine-tuning parameters (e.g., weights and bias updates) using learning algorithms, such as gradient descent. A neural network may comprise layers of neurons that include input layers, hidden layers, and an output layer, as shown in FIG. 1. Neurons may comprise fundamental processing units of a neural network, which sum up inputs and apply a non-linear function to produce output. Each neuron in one layer connects to every neuron in a subsequent layer, thereby forming a dense network where computational operations occur.

Weights and biases may comprise parameters that may be used to optimize the neural network through learning. Weights may control the impact of input signals on the output, while biases may allow a model to fit better with the data by adjusting the output independently of the input. Activation functions may introduce non-linear properties to the neural network, enabling it to learn complex patterns. Common examples include the sigmoid, tanh, and rectified linear unit (ReLU) functions.

Hardware implementations of neural networks incur high energy consumption due to intensive computing workloads that are inherent to the neural network(s). The present disclosure discloses an energy-efficient neural network design that effectively explores optimization and computation reuse. In some embodiments, a hardware-software co-design is utilized.

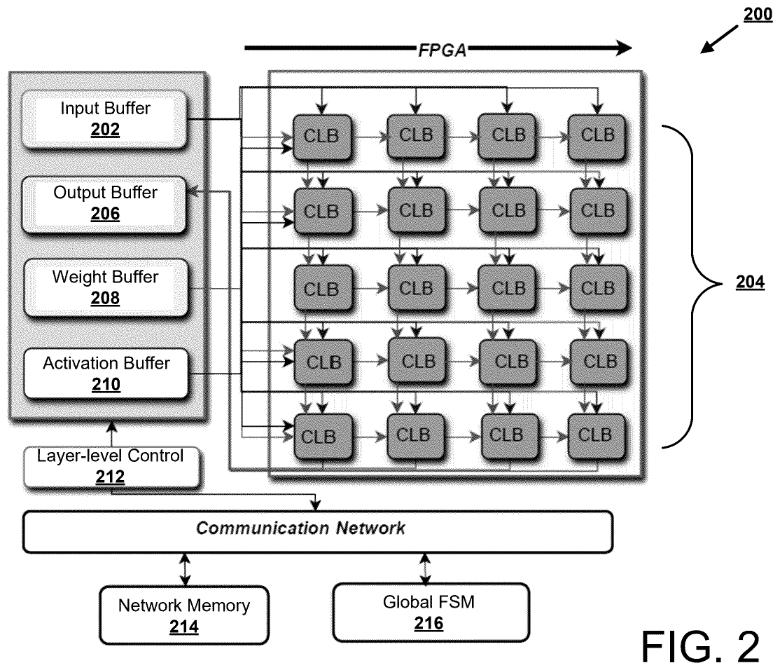

FIG. 2 is a schematic of an example FPGA 200 implementation of a neural network. An input buffer 202 may temporarily store input data. The input data may be in various forms, such as sensor readings, image pixels, or any other input type relevant to the neural network's task. Data from the input buffer 202 may be provided to the FPGA's 200 combinational logic blocks (CLBs) 204. A weight buffer 208 may be configured to store weights associated with connections between neurons in the neural network. A connection in the neural network may comprise an associated weight that determines the strength of the connection and may be provided to the CLBs 204 for computation. An activation buffer 210 may be configured to temporarily store intermediate results (activations) that may be generated by neurons in each neural network layer. The output buffer 206 may comprise a component that facilitates efficient handling, formatting, and transfer of final output data. The layer-level control 212 unit may be configured to interact with CLBs 204, network memory 214, and/or global FSM 216 during layer-wise computation by controlling data movements between input buffer 202, output buffer 206, weight buffer 208, and/or activation buffer 210.

With respect to neural network operations, the CLBs 204 may be configured to perform neuron computation, matrix multiplication, and activation functions in neural network operations. Neuron computation may comprise performance of a weighted sum of each neuron's inputs followed by an activation function. Matrix multiplication may comprise a core operation in neural networks. Matrix multiplications may be mapped onto CLBs 204 by breaking the matrix multiplications down into smaller operations that are distributed across multiple CLBs 204 to exploit parallelism. Activation functions may comprise ReLU, sigmoid, and tanh that may be implemented within CLBs 204 using LUTs and/or other logic elements.

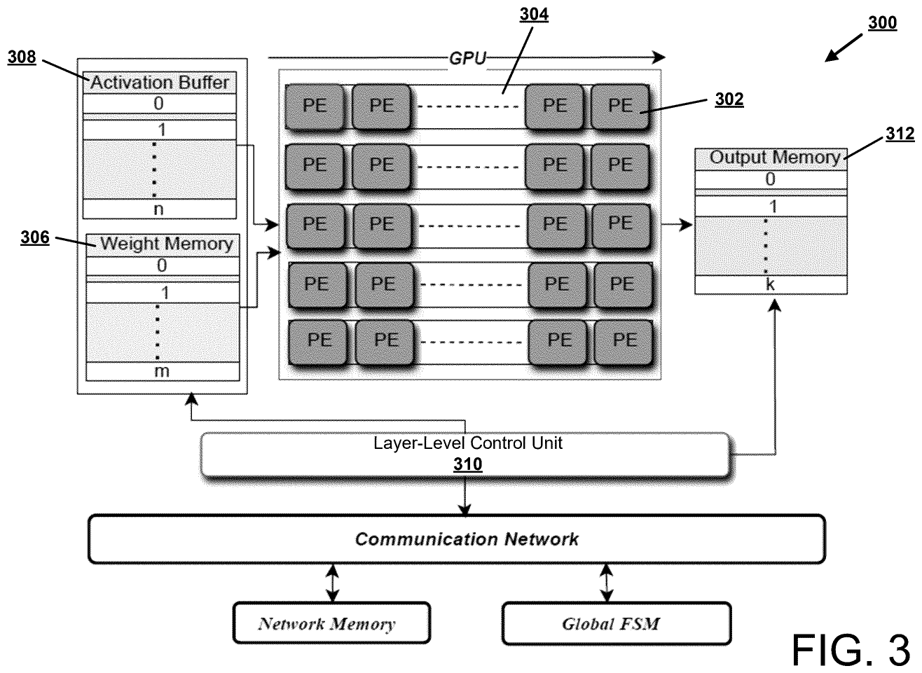

FIG. 3 is a schematic of an example graphics processing unit (GPU) 300 implementation of a neural network. Parallel processing capabilities of a GPU 300 may be leveraged to accelerate training and inference of neural networks. GPUs may be suited for the computational demands of neural networks due to their architecture, which allows for simultaneous execution of many operations. An input buffer may receive and preprocess input data. The preprocessed input data may then be transferred from a CPU to the GPU's 300 processing elements (PEs) 302. The GPU 300 may be divided into a plurality of compute units (CUs) 304, where a compute unit 304 comprises a plurality of PEs 302.

The PEs 302 may execute parallel computations across multiple threads, utilizing single instruction, multiple threads (SIMT) architecture. PEs 302 within the CUS 304 may execute matrix multiplications in parallel, where each PE 302 may handle a portion of the multiplication. A weight memory 306 may provide weights during computation to PEs 302 and an activation buffer 308 may apply non-linear activation functions (e.g., ReLU, sigmoid, tanh) to results of matrix multiplication computations. A layer-level control unit 310 may control layer-wise operation within the PEs 302 by interacting with the activation buffer 308, weight memory 306, and/or the output memory 312. The output memory 312 may be configured to transfer final output data from the PEs 302.

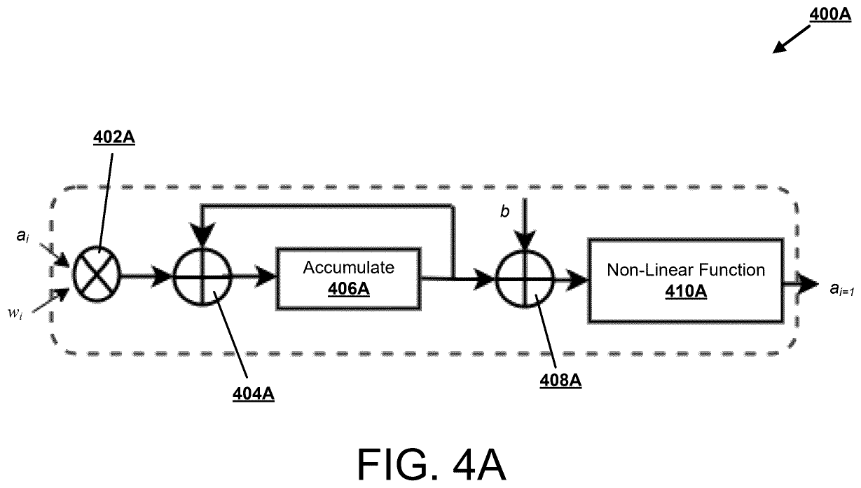

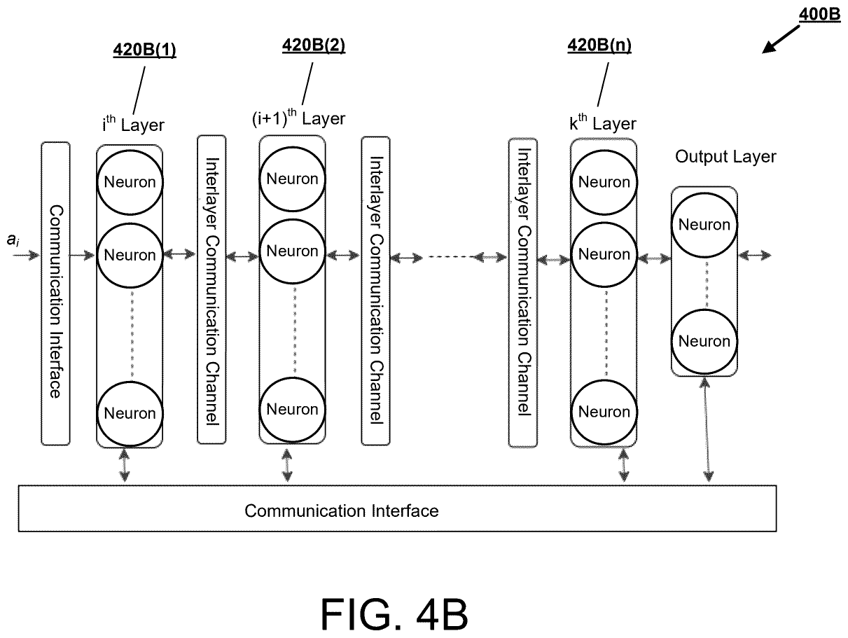

FIG. 4A and FIG. 4B are example circuit diagrams for implementing neural networks. The aᵢ may comprise an input and weight wᵢ may be fetched from weight memory. In a computing neuron node 400A, as depicted in FIG. 4A, a multiplier 402A multiplies activation (aᵢ) with weight (wᵢ) to generate a partial product 404A where each partial product 404A is added to a previous sum accumulated in the accumulate unit 406A. A final product 408A is added with a bias (b) and a final activation (aᵢ₌₁) is generated through a non-linear activation function 410A.

FIG. 4B depicts an example architecture 400B of a neural network. Each layer neuron node 420B(1), 420B(2), . . . 420B(n) in FIG. 4B are examples of the computing neuron node 400A node in FIG. 4A. A layer neuron node (420B(1), 420B(2), . . . 420B(n)) may comprise a multiplier, an adder, and/or an activation function implementing unit, which may result in excessive energy consumption with bulky hardware overhead. General neural network hardware implementation may demand significant energy consumption and computational resources for performing complex computations that handle millions of parameters and hundreds of hidden layers in deep neural networks, leading to time-consuming processes and large energy consumption.

### Example Pre-Computation-Based Energy-Efficient Neural Network (PENN) Framework

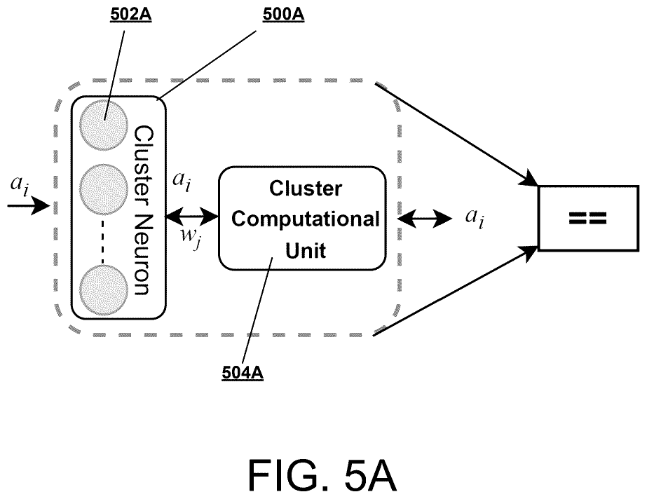

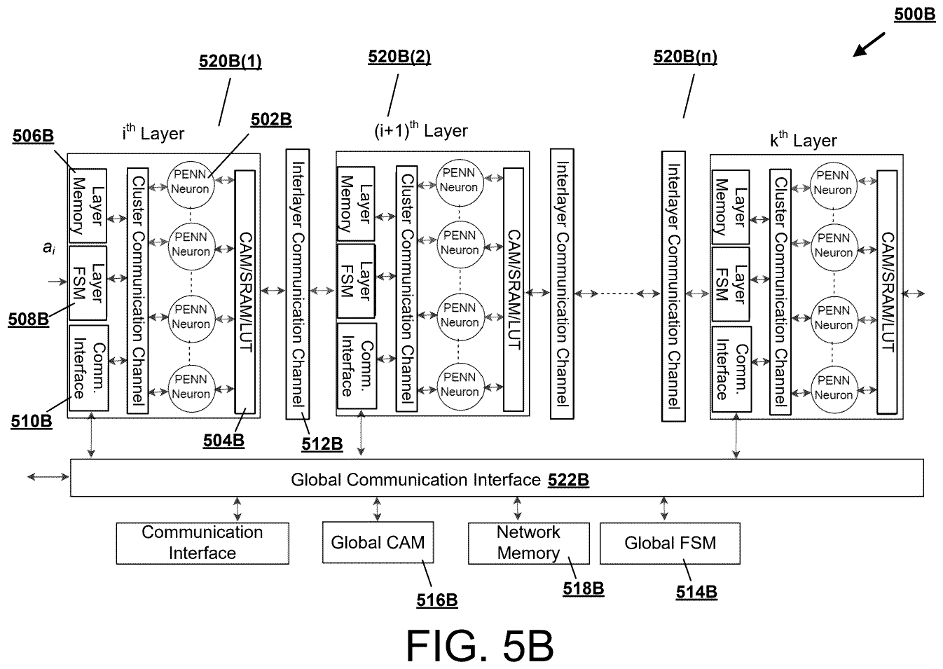

FIG. 5A is a diagram of an example PENN neuron cluster 500A in accordance with some embodiments of the present disclosure. The PENN neuron cluster 500A may comprise a plurality of PENN neurons 502A (e.g., comprising modified neurons relative to computing neuron node 400A), each of which may include a MAC unit, an FSM, and a pre-compute storage memory (e.g., CAM/SRAM/LUT) unit. The plurality of PENN neurons 502A may be coupled to a cluster computational unit 504A that is configured to compute values for the plurality of PENN neurons 502A within the PENN neuron cluster 500A.

A PENN neuron 502A may comprise a lookup-based implementation. A lookup-based technique for implementing neural networks may be beneficial in the context of energy efficiency, speed, and hardware constraints. According to various embodiments of the present disclosure, a lookup-based implementation may share resources by utilizing LUTs that store pre-computed results for neural network operations, enabling efficient reuse of these results across different computations. As such, energy consumption and computational resources may be reduced by sharing and reusing computational resources, thereby avoiding high-frequency repeated computation.

FIG. 5B is a block diagram of an example system architecture 500B of a PENN neural network framework at the hardware level. PENN neural layers 520B(1), 520B(2), . . . 520B(n) (i^{th} layer, (i+1)^{th} layer, and to the k^{th} layer) may comprise modified neurons 502B (e.g., PENN neuron cluster 500A), layer CAM/SRAM/LUT 504B, layer memory 506B, layer FSM 508B, and a communication interface 510B. Inter-layer communication channels 512B are configured between two consecutive PENN neural layers of 520B(1), 520B(2), . . . 520B(n) for communication therebetween.

The layer hardware corresponding to the PENN neural layers 520B(1), 520B(2), . . . 520B(n), global FSM 514B, global CAM(/SRAM/LUT) 516B, and (neural) network memory 518B are connected through a global communication interface 522B for inter-communication. In some embodiments, the global communication interface 522B may also be configured to communicate with a host (e.g., software, cloud, FPGA, GPU, etc.).

A lookup-based PENN implementation may utilize various properties, such as data sparsity, skewed frequency, resource sharing, constant input, and regularity in architecture to achieve optimized energy efficiency and improved overall performance in neural network hardware.

Sparsity of Data: Using the sparse data property, LUTs may be designed to store non-zero elements to reduce memory usage. In a sparse neural network, computations may result in zero or near-zero values that may be skipped or approximated using simpler operations. As such, the number of memory accesses and computations may be reduced, thereby enhancing speed and energy efficiency.

Skewed Frequency: LUTs may be configured to store certain values or operations that occur more frequently than others. For example, frequently encountered results may be stored in more accessible parts of memory to skip computation and reduce access latency. Implementing mechanisms for frequently accessed data may speed up computation.

Sharing Resources: A lookup-based technique may optimize neural network operations by sharing resources, such as memory or computational units. For example, multiple neural neuron/layers or operations of a neural network may share LUTs if they have overlapping data or computation patterns.

Constant Input: Pre-computed results for inputs of a neural network that are constant or change infrequently may be stored in LUTs to obviate the need for repetitive computation upon every instance a constant or infrequently changing input is encountered. For tasks with constant input patterns, pre-computed LUTs may provide immediate results thereby speeding up inference processes.

Uniformity/Regularity of Neural Network Architecture: A lookup-based technique may exploit the uniformity and regularity in neural network architectures. That is, regular, repetitive structures in neural network layers may enable predictable computation patterns, allowing LUTs to store and quickly retrieve pre-computed results. Such consistency may simplify table design and optimize memory access, enhancing speed and efficiency in neural network operations.

As disclosed herewith, a lookup-based PENN implementation may comprise using LUT, SRAM, and/or CAM to provide pre-computation reuse in neural network inference and training phases. Energy efficiency may be achieved by leveraging repetitiveness to reduce workload during MAC operations. In some example embodiments, pre-computed multiplication results for frequently reoccurring input patterns may be stored in LUT, SRAM, and/or CAM arrays for reuse, thus eliminating redundant computations for common operations.

In some embodiments, a CAM-based PENN may comprise an associative memory that is integrated into a processing unit of a neural network for storage of pre-compute intermediate results that may be accessed for achieving fast and efficient neural network operations. A CAM-based implementation may facilitate retrieval of intermediate results by using a combined key between operands to bypass frequent common computational calculations.

In some embodiments, a LUT/SRAM-based PENN may comprise a LUT/SRAM array that is configured to store and provide access to multiplication result values. Based on an input operand, a respectively corresponding multiplication result value that is stored in the LUT/SRAM array may be retrieved to compute an activation of a neuron of a next layer, thereby skipping performance of a multiplication operation which may result in a reduction of energy consumption and computational time. A LUT/SRAM-based implementation may allow the retrieval of intermediate results by using an activation key to skip multiplication operations.

Table 1 provides example operand pairs for PENN implementation in CNNs, DNNs, and recurrent neural networks (RNNs) for inferencing and training.

TABLE 1

| Network Type | During Inferencing | During Training |
|---|---|---|
| DNN | i) {Input activations, Weights} | i) {Input activations, Weights} |
| | | ii) {Activation values, Gradients} |
| | | iii) {Gradients, Weights} |
| CNN | i) {Input feature map, Filter | i) {Input feature map, Filter weights} |
| | weights} | ii) {Activation maps, Gradients} |
| | ii){Activation maps, Fully | iii) {Gradients, Weights} |
| | connected layer weights} | iv) {Activation maps, Input feature |
| | | maps} |
| RNN | i) {Input at time t, Hidden state | i) {Input at time t, Hidden state at time |
| | at time t − 1} | t − 1} |
| | ii){Hidden state at time t − 1, | ii) {Hidden state at time t − 1, Recurrent |
| | Recurrent weights} | weights s} |
| | iii) {Hidden state at time t, Out- | iii) {Hidden state at time t, Out-put |
| | put weights} | weights} |
| | | iv) {Hidden state at time t, Gradient of |
| | | loss with respect to hidden state at |
| | | time t} |
| | | v) {Gradients, Weights} |

In some embodiments, a lookup-based implementation may be extended to backpropagation computations. Backpropagation may comprise a technique for optimizing neural networks by computing gradient descent with respect to neural network weights based on the chain rule. Specifically, performing backpropagation may involve a considerable amount of multiplications of partial derivates during chain rule operation. Accordingly, various embodiments of the present disclosure may comprise using LUT, SRAM, and/or CAM arrays for storing and reusing frequently occurring derivate values in memory during backpropagation operations.

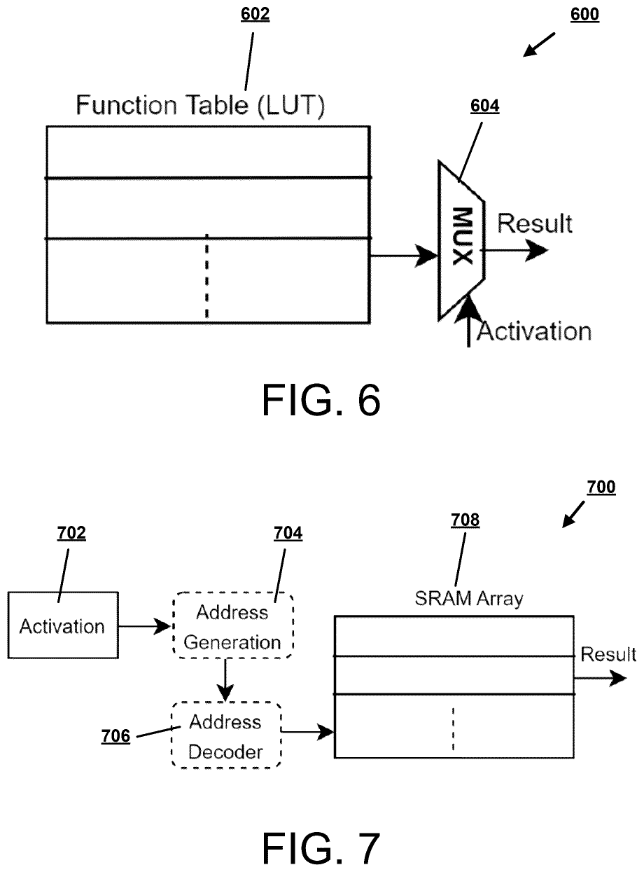

FIG. 6 is a diagram of an example LUT configuration 600 in accordance with some embodiments of the present disclosure. In some embodiments, a LUT-based PENN may share resources by utilizing LUTs that store pre-computed results for neural network operations. As such, the pre-computed results may be efficiently reused across different computations. In some embodiments, weights and activations are quantized and computational results may be achieved using the quantized weights and activations. The function table (LUT) 602 may store pre-computed output values for each set of quantized inputs. In some embodiments, the function table (LUT) 602 allows for fast lookup operations that replace complex arithmetic computations. A MUX 604 may be configured to select an appropriate output value from the function table based on the quantized input indices. The MUX may use the quantized indices as select lines to choose a corresponding output from the function table.

FIG. 7 is a diagram of an example SRAM configuration 700 in accordance with some embodiments of the present disclosure. A SRAM-based PENN may improve access speed and reduce energy overhead that is associated with frequent memory access. In some embodiments, a SRAM-based PENN may utilize SRAM to store intermediate results that are accessible for sharing among multiple neural network operations. As depicted in FIG. 7, an address is generated (704) based on an input activation 702 and structure of a neural network. An address decoder 706 may translate the generated address 704 into a specific location within an SRAM array 708 where computational results may be stored. The address decoder 706 may ensure that correct memory cells are accessed. Based on the input activation 702, computational results may be provided as output that is read and used to calculate/determine activation of a next layer.

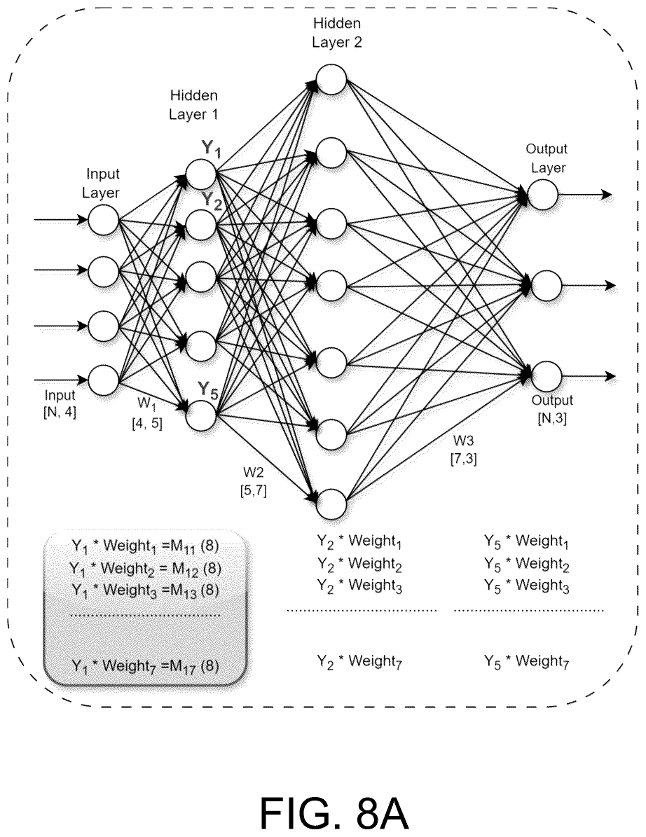

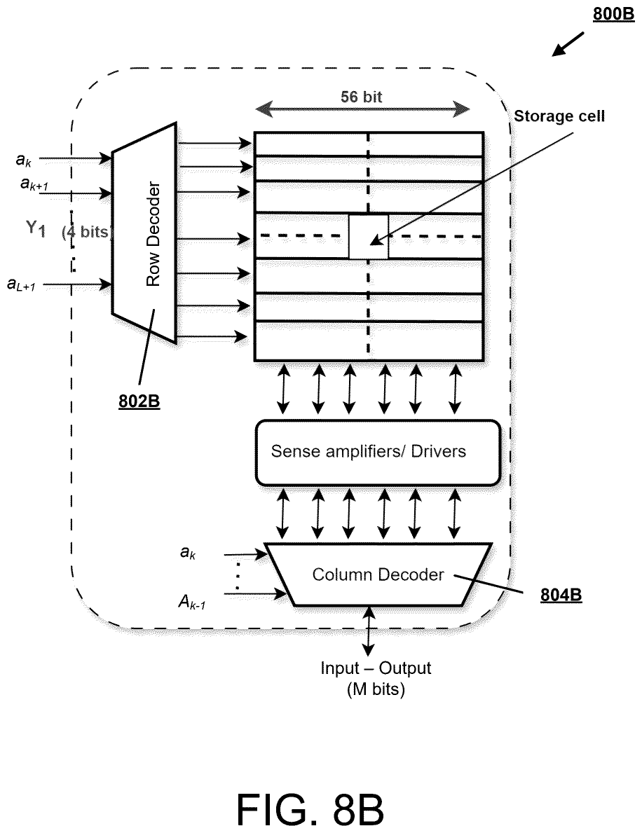

FIG. 8A depicts resource sharing in an example SRAM-based implementation in accordance with some embodiments of the present disclosure. As depicted in FIG. 8A, an input layer comprising 4 inputs may generate four output activations. The hidden layer-1 comprising 5 neurons may generate 5 output activations. Similarly, hidden layer-2 comprising 7 neurons may generate 7 output activations. The 7 output activations feed to an output layer that comprises 3 nodes.

FIG. 8B depicts an example SRAM array 800B in accordance with some embodiments of the present disclosure. The SRAM array 800B comprises a size of 16 rows×56 columns bits. A 4×16 address row decoder 802B may be configured to generate a row address that selects a row of the SRAM array 800B. An address column decoder 804B may generate an address that selects one out of 7 bytes from the particular row.

The effective address=a_{L-1}, . . . , aₖ₊₁, aₖ, aₖ₋₁, . . . , a₀

The Row address=a_{L-1}, . . . , aₖ₊₁, aₖ

The column address=aₖ₋₁, . . . , a₀

The address row decoder 802B may select 24 rows and each row may store 8 bytes or 64 bits of data. As there are 8 (23) bytes in each row, a 3 bit address is used to select each byte data.

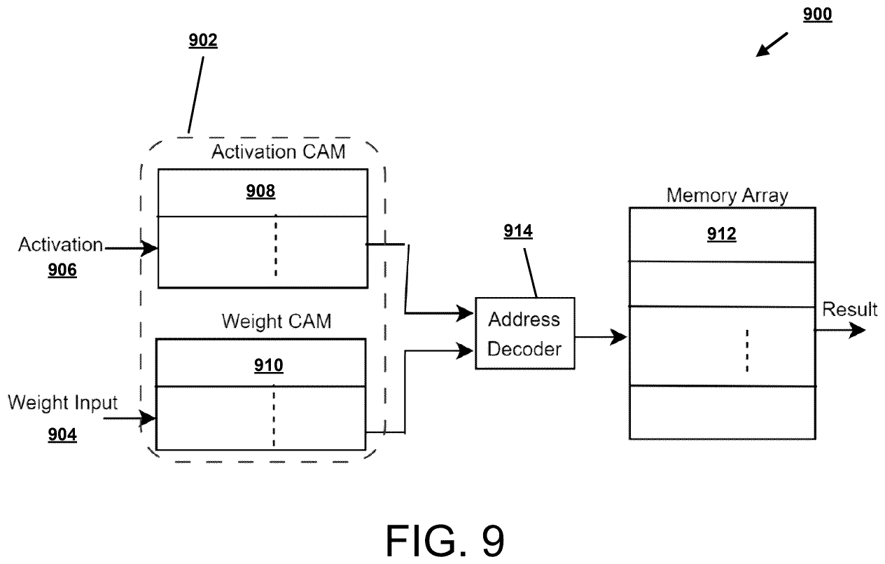

FIG. 9 is a diagram of an example CAM-based PENN 900 in accordance with some embodiments of the present disclosure. In some embodiments, a CAM-based PENN 900 may be used to efficiently store and retrieve weights and activations based on content. For example, most frequently encountered input operand sets (weight input 904 and activation 906) for given computational values are stored in a CAM array 902. The CAM array 902 comprises an activation CAM 908 and a weight CAM 910. The activation CAM 908 may be configured to store frequently encountered input activations and the weight CAM 910 may be configured to store weights corresponding to the frequently encountered input activations. Before a MAC operation is initiated at a neuron with input operands, a weight and activation set from the CAM array 902 may be compared with the input operands stored in the CAM array 902. The CAM array 902 may be configured to store common input operand patterns (e.g., weight and activation sets), while a memory array 912 may be configured to store pre-processed computational results. If a match is found in the CAM array 902, then a respectively corresponding pre-processed computation result may be fetched from the memory array 912 instead of performance of a MAC operation. As such, an address decoder 914 may generate addresses of a memory block in memory array 912 based a value corresponding to the match in CAM array 902 to fetch multiplication results from a location of the memory block for use in the computation of activation of a next layer in a neural network.

### Example System Operations

Various embodiments of the present disclosure describe steps, operations, processes, methods, functions, and/or the like for implementing energy and computationally efficient neural networks. In some embodiments, realizing the PENN framework for a given neural network comprises a software-hardware co-design process.

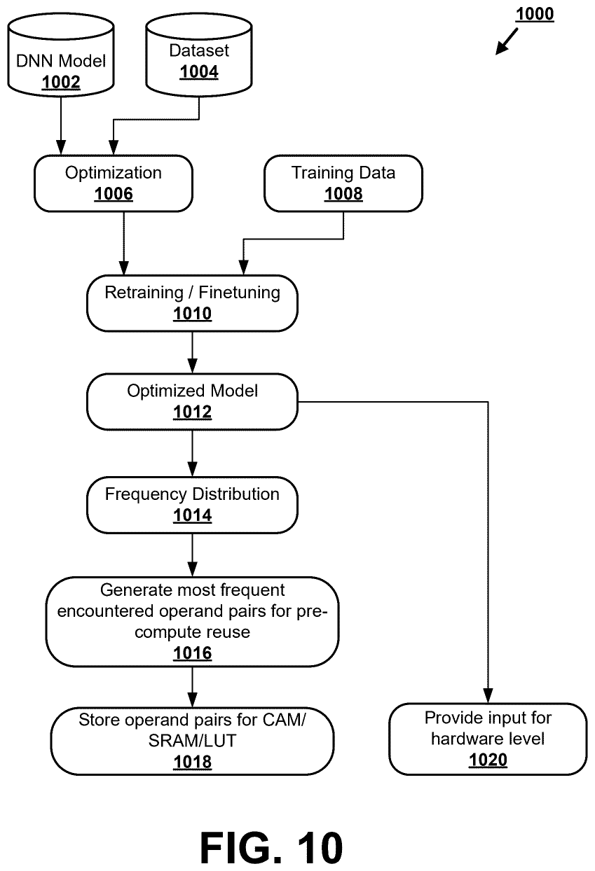

FIG. 10 is a flowchart of an example PENN software design process 1000 in accordance with some embodiments of the present disclosure. In some embodiments, via the various steps/operations of the PENN software design process 1000, a desired machine learning model may be optimized.

In some embodiments, the process 1000 begins at step/operation 1006 when a computing system initiates an optimization of a DNN model 1002 with dataset 1004.

In some embodiments, at step/operation 1010, the computing system further re-trains and/or fine-tunes the optimized DNN model with training data 1008 before being provided to a PENN hardware design phase.

In some embodiments, at step/operation 1012, the computing system optimizes the re-trained/fine-tuned model.

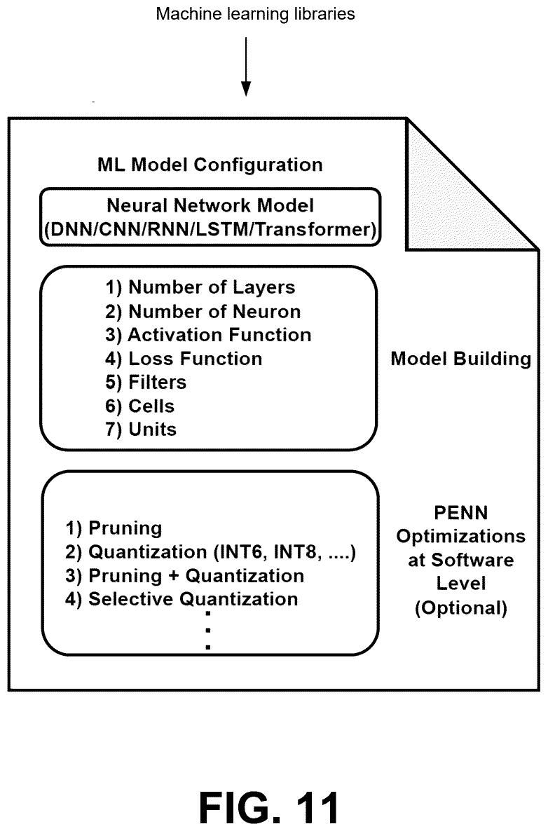

FIG. 11 depicts example parameters for generating and optimizing a machine learning mode in accordance with some embodiments of the present disclosure. Any machine learning library may be used to generate the machine learning model. In some embodiments, generating a machine learning model comprises defining an architecture of a neural network during a software design phase. Defining the architecture may comprise determining one or more parameters, such as number of neurons per layer, total number of layers and their connectivity amongst each other, feature extraction protocols, etc. One or more PENN optimizations may then be applied to the machine learning model. In some embodiments, the one or more PENN optimizations may comprise applying pruning and/or quantization optimization techniques to optimize energy and computation efficiency.

Referring back to FIG. 10, in some embodiments, at step/operation 1014, the computing system generates a frequency distribution of operand pairs (e.g., input patterns comprising activations and respectively corresponding weights).

In some embodiments, at step/operation 1016, the computing system determines most frequently occurring/encountered operand pairs from the frequency distribution and multiplication results that respectively correspond to the most frequent operand pairs are determined for pre-compute reuse.

In some embodiments, at step/operation 1018, the computing system stores the most frequent operand pairs and their multiplication results in a pre-compute storage memory (e.g., CAM/SRAM table or memory array).

In some embodiments, at step/operation 1020, the computing system provides input for the hardware level.

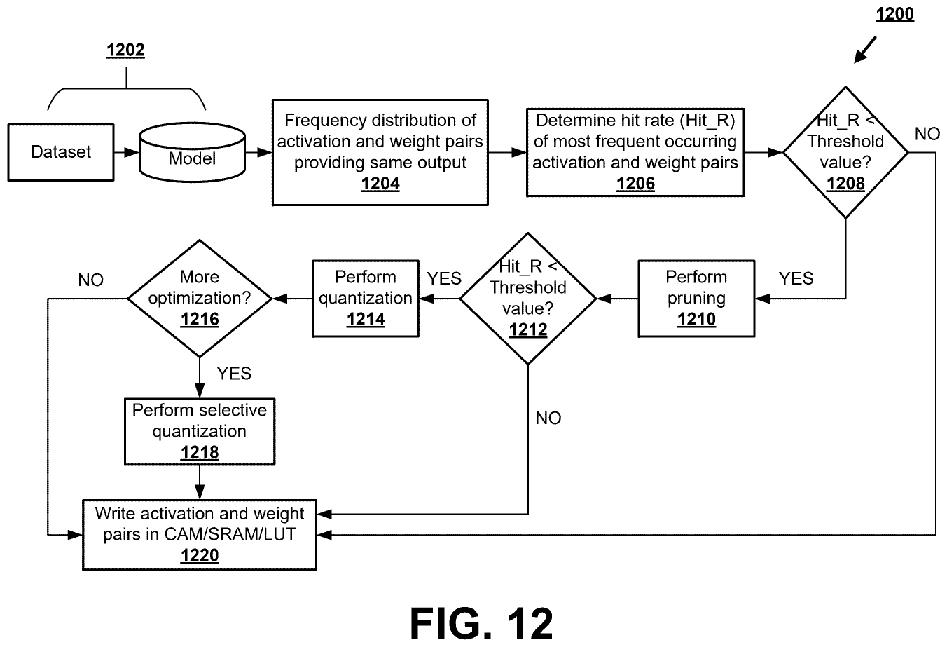

FIG. 12 is a flowchart of an example CAM-based PENN software implementation process 1200 in accordance with some embodiments of the present disclosure. In some embodiments, before implementing computation reuse strategies, most frequent input patterns and their associated multiplication results are determined. In some embodiments, input operands (activations and associated weights) of multiplications are profiled using training inputs. The most frequent input patterns may be determined based on the profiling and their results may be calculated. Accordingly, the most frequent input patterns and their results may be stored in a memory system for computational reuse.

In some embodiments, the process 1200 begins at step/operation 1202 when a computing system selects a DNN or CNN machine learning model for implementation. A certain percentage of a dataset may be used to train the DNN or CNN machine learning model.

In some embodiments, at step/operation 1204, the computing system determines a frequency distribution of the most frequent occurred input patterns (e.g., activation and weight) pairs for common computational output.

In some embodiments, at step/operation 1206, the computing system determines the frequency (e.g., number of repetitions) or hit rate (Hit_R) of most frequently encountered activation and weight pairs providing the same computational output.

In some embodiments, at step/operation 1208, the computing system determines if the Hit_R is less than a threshold value (TV). For example, the HIT rate may be low, below at 9-10%, and as such, the HIT rate may be improved by applying pruning and/or quantization of weights and associated activations.

In some embodiments, at step/operation 1210, if the computing system determines Hit_R is less than threshold value (e.g., >0.50), the DNN or CNN machine learning model may be optimized via pruning. Pruning may be performed to achieve an optimized DNN or CNN machine learning model by removing redundant synapses (weights) and neurons.

In some embodiments, at step/operation 1220, if the computing system determines the Hit_R is achieved (i.e., is not less than TV, step/operation 1212), then optimization may be stopped, and most frequently encountered input operand pairs may be stored in a CAM/SRAM table.

In some embodiments, at step/operation 1212, if the computing system determines Hit_R is less than threshold value after pruning, further optimization may be performed.

In some embodiments, at step/operation 1214, if (Hit_R<TV) or if further optimization is desired, the computing system performs quantization. Quantization strategies may be used for input operands and a frequency distribution may be performed.

In some embodiments, at step/operation 1216, if more optimization is desired, then selective quantization is performed at step/operation 1218, otherwise most frequently encountered input operand pairs may be stored in the CAM/SRAM table at step/operation 1220. In some embodiments, a set of most frequently input operands may be stored in the CAM/SRAM table and respectively corresponding resultant (multiplication computational outputs may be stored in block random-access memory (RAM) associated with CAM/SRAM Table. Accordingly, computation reuse may be achieved by storing the most frequently encountered input operand pairs in the CAM/SRAM table and their associated computation results in the memory block.

According to various embodiments of the present disclosure, computation reuse strategies may be leveraged in neural networks to mitigate energy overhead from re-execution and introduce optimization techniques to enhance reuse. Two strategies may be considered for finding the most frequently encountered input operand pairs: global search and layer-based search. In some embodiments, for global search, an entire neural network may be considered for searching the most frequently encountered input operand pairs and the most frequent input operands may be considered for the multiplication operations in neural network inferences regardless of their locations.

In some embodiments, for layer-based search, frequent input operands may be determined for each layer. Most frequent operands may be found from input operands of multiplications profiled from a specific layer. For example, to find the most frequent patterns in a first hidden layer, input operands of multiplications in the first hidden layer may be profiled to identify the most common patterns among the input operands in the first hidden layer. In some embodiments, an occurrence (e.g., Hit_R) of a chosen frequent pattern may be recorded for various input patterns for each layer. In some embodiments, layer-based search may comprise a higher hit rate compared to the global search. As the number of stored patterns increases, the Hit_R may also increase. In some embodiments, Hit_R may be calculated among the most frequently encountered pairs. For example, for INT6 precision representation, 32 top pairs may be considered and the row size of a CAM Table may be 32.

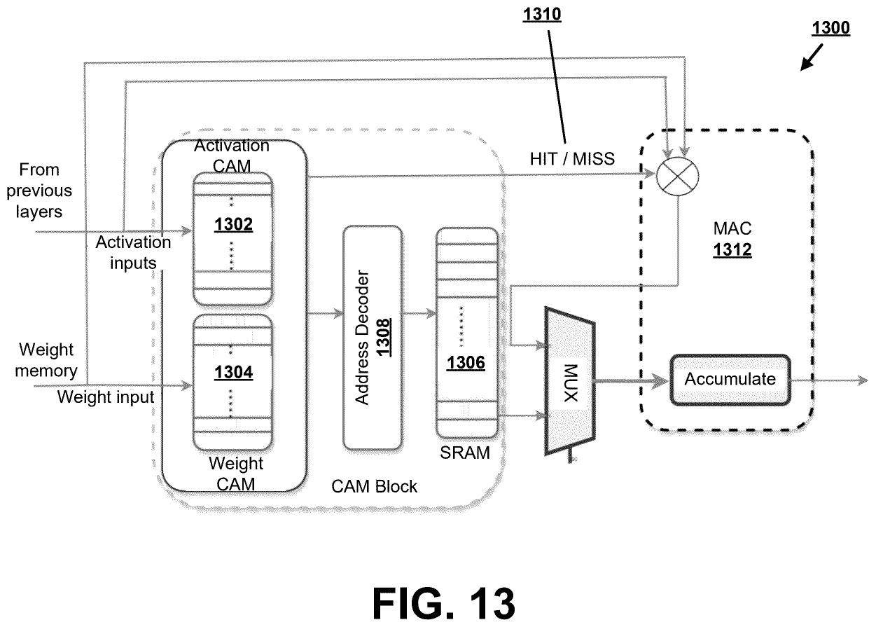

FIG. 13 is a diagram of an example CAM pre-compute block 1300 in accordance with some embodiments of the present disclosure. To obtain the output of a neuron, an activation matrix may be first multiplied to a weight matrix and to which a bias may be added. An intermediate value may then be passed as input to an activation function that is specific to the neuron. The output of the activation function may comprise the final output of the neuron.

As depicted in FIG. 13, a CAM pre-compute block 1300 comprises two CAMs (an activation CAM 1302 and a weight CAM 1304), a SRAM 1306, an address decoder 1308, and logic 1310 for generating a hit/miss signal. The CAM pre-compute block 1300 may be associated with a MAC unit 1312. The activation CAM 1302 and the weight CAM 1304 may be dedicated to the most frequent activations and weights respectively, and corresponding multiplications may be stored in the SRAM 1306. In some embodiments, values stored in the activation CAM 1302 and the weight CAM 1304 may be decoded to generate an address for multiplication to write or read in the SRAM 1306. During inferencing or training, an activation input value and weight value of a neuron may be provided to the CAM pre-compute block 1300 and values of the activation CAM 1302 and the weight CAM 1304 may be compared with the activation input value and the weight value. If both the activation and weight values match with the corresponding activation CAM values and weight CAM values stored, a HIT signal may be generated and a multiplication result may be retrieved from the SRAM 1306; otherwise multiplication may be computed in the MAC unit 1312. In some embodiments, a number of locations of SRAM 1306 may equal to a number of distinct output values generated corresponding to frequent input (e.g., operand) pattern pairs. The activation CAM 1302 and the weight CAM 1304 may store the patterns corresponding to respective assigned output values.

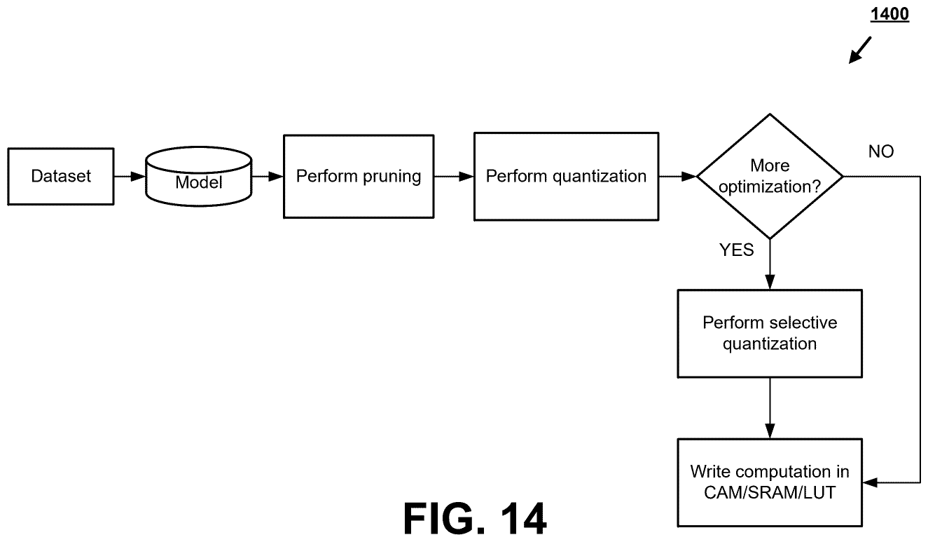

FIG. 14 is a flowchart diagram of an example software implementation process 1400 for a LUT/SRAM-based PENN in accordance with some embodiments of the present disclosure. In LUT/SRAM based implementations, similar to the CAM-based PENN software implementation process 1200 in FIG. 12, a neural network may encode weights and activations. In some embodiments, the weights and activations may be pruned and quantized. The computations associated with the optimized weights and activations may then be stored in a LUT or SRAM array.

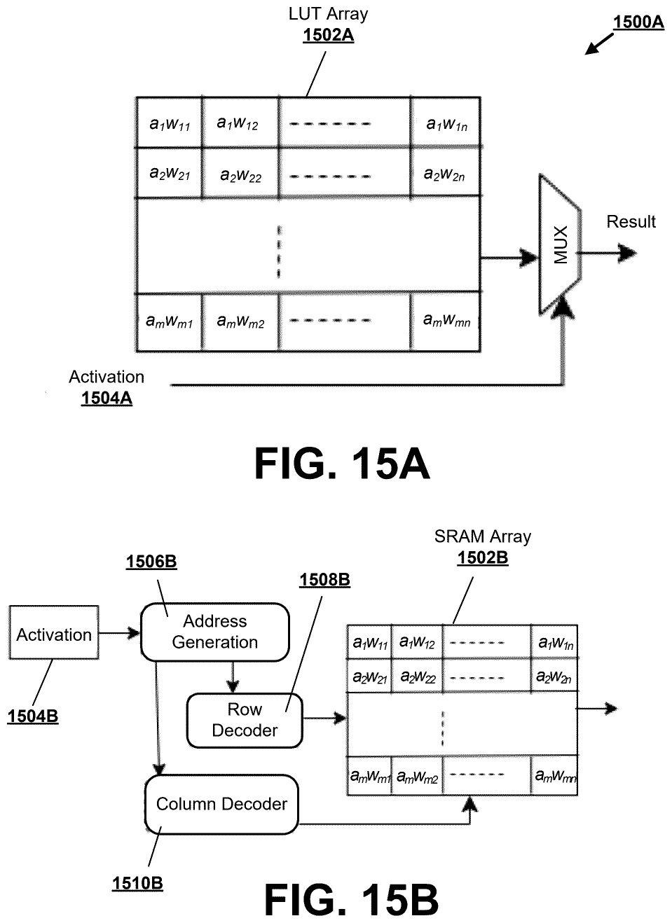

FIG. 15A and FIG. 15B are example schematic diagrams of a LUT-based PENN 1500A and a SRAM-based PENN 1500B, respectively, in accordance with some embodiments of the present disclosure. Pre-computed values may be accessed from LUT array 1502A and SRAM array 1502B, respectively. During inference, activation 1504A/1504B may be provided as input and used to index the LUT/SRAM arrays 1502A/1502B. Based on the activation 1504A/1504B, computational results may be read and used to calculate the activation of the next layer. That is, the LUT/SRAM arrays 1502A/1502B may provide pre-computed output corresponding to the index. As such, inference may be expedited by avoiding the performance of multiplication and addition operations. Accordingly, a need for complex computations may be reduced during inference resulting in reduced energy consumption due to reduced arithmetic operations.

In SRAM-based PENN 1500B, an address may be generated (1506B) based on activation 1504B and the structure of the neural network. An address decoder comprising row decoder 1508B and column decoder 1510B may translate the generated addresses 1506B into specific locations within the SRAM array 1502B where computational results may be stored. The address decoder may ensure that the correct memory cells are accessed.

According to various embodiments of the present disclosure, pruning, quantization, or quantization with pruning optimization techniques may be integrated into the disclosed PENN framework at both the software and hardware design phases.

In some embodiments, pruning may comprise removing weights and activations with low magnitude that have minimal impact on a final model's performance. The original and pruned models maintain the same architecture, but the pruned model may become sparser as weights with low magnitude are set to zero. Pruning techniques may be divided into unstructured or structured approaches. Unstructured pruning techniques may offer higher compression rates. Unstructured pruning may provide improved compression rates while maintaining the accuracy of original DNNs.

Structured pruning may be implemented by removing and/or deleting unimportant structures contained in a whole machine learning model, such as convolution kernels, channels, filters, layers, and so on. During training, weight updates may be pruned. For example, as gradient magnitude of a DNN stabilizes, the magnitude of further weight updates may not exhibit significant variations and may become relatively constant. As such, such further weights may be pruned. Input and weight multiplications may then be determined to generate a frequency distribution. Based on the frequency distribution, top-occurring input pairs may be stored along with their calculated values in a LUT/SRAM/CAM. After that, the DNN may be stored and trained. Thus, overall computation of multiplications may be reduced and a total size of a DNN may also be reduced.

Quantization may discretize the range of weight or activation values such that each value may be represented using fewer bits. Uniform or non-uniform quantization may be used to provide quantized models. By altering step size, distribution of quantization levels may be changed. In uniform quantization, the step size is constant where the precision of weights and activations may be represented using the same number of bits. Uniform quantization may reduce the activations and weights of neural networks to a narrow range of values. Uniform quantization may be organized as symmetric or asymmetric.

The precision of the operands may be represented via integer-only quantization (i.e., fixed-point quantization) or simulated quantization (i.e., fake quantization).

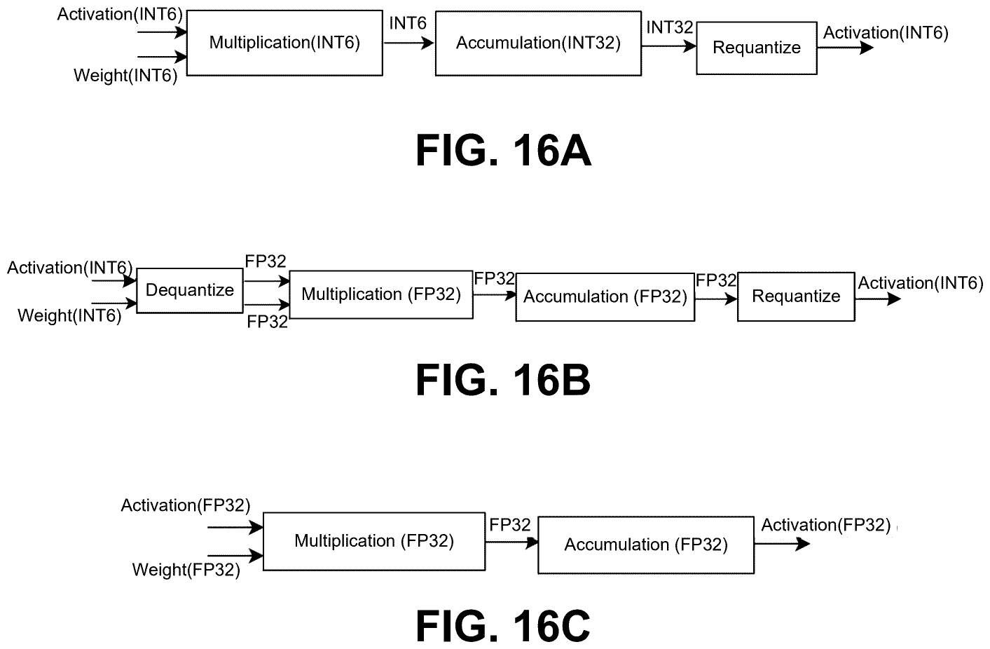

FIG. 16A depicts an example of integer-only quantization in accordance with some embodiments of the present disclosure. In integer-only quantization, operations may be performed using low-precision integer arithmetic. This permits an entire or majority of inference to be carried out with efficient integer arithmetic without floating point de-quantization of parameters.

FIG. 16B depicts an example simulated quantization in accordance with some embodiments of the present disclosure. In simulated quantization, quantized model parameters may be stored in low-precision, but operations, such as matrix multiplications and convolutions, may be carried out with floating point arithmetic. The quantized parameters may be dequantized before floating-point operations.

FIG. 16C depicts an example full-precision quantization in accordance with some embodiments of the present disclosure. Full-precision quantization with floating point arithmetic may help with final quantization accuracy at the cost of computing overhead and more energy consumption. Whereas, low-precision may provide multiple benefits in terms of latency, power consumption, and area efficiency.

Full-precision with floating point arithmetic may cause a neural network to consume more memory. For example, a neural network with millions of parameters and activations may store parameters as 32-bit values. In some example embodiments, a 50-layer ResNet architecture may comprise approximately 26 million weights and 16 million activations, where 168 MB of storage may be used to store both the weights and activations represented using 32-bit floating-point values for both the weights and activations. Quantization may comprise different techniques to convert input values from a large set to output values of a smaller set. A deep learning model used for inferencing may be perceived as a matrix with complex and iterative mathematical operations which mostly include multiplications. Accordingly, converting 32-bit floating values to 8 bits integer may lower precision of weights used.

To convert a 3×3 weight matrix of floating-point values into an INT6 matrix, a systematic procedure may be followed to ensure optimized weight matrices for hardware implementations specifying low-bit-width representations.

In some embodiments, a maximum absolute value within a matrix, max_val, is identified. The max_val may be used to determine a scaling factor:

$${scale}_{factor} = \frac{31}{max\_val} \qquad Equation 1$$

Each element wᵢⱼ of an original matrix W may then be scaled:

$${W}_{scaled} [ i ] [ j ] = W [ i ] [ j ] \times scale\_factor \qquad Equation 2$$

The scaled values may be rounded to nearest integers to fit within the INT6 range:

$${W}_{int 6} [ i ] [ j ] = round ( {W}_{scaled} [ i ] [ j ] ) \qquad Equation 3$$

The scaled values may be cast to integer type to ensure that the values are within the INT6 range of −32 to 31. The resulting matrix Wint6 may retain the relative magnitudes of the original matrix within the constraints of the INT6 format.

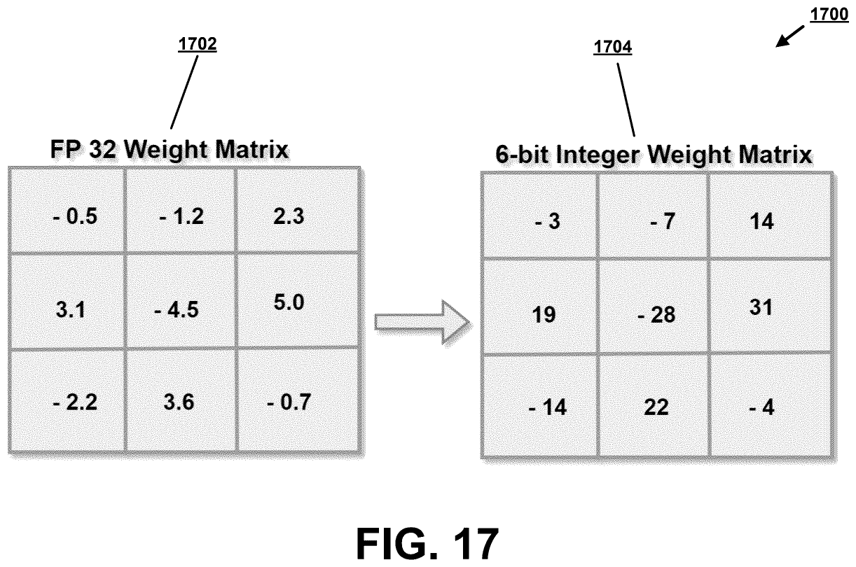

FIG. 17 depicts an example conversion 1700 of FP32 to INT 6-bit in accordance with some embodiments of the present disclosure. The (3×3) weight matrix represented in FP32 weight matrix 1702 is converted into a (3×3) 6-bit integer weight matrix 1704.

Energy usage may be mainly driven by data movement, and as such, using lower precision representations may reduce energy consumption during inference. Lower precision representations may be achieved by decreasing memory needed to load and store weights and activations while also boosting computational speed.

In some example embodiments, following the training of a model using 32-bit floating-point precision (FP32), it may be subsequently loaded and prepared for inference. The model may undergo quantization, where it is converted from floating point to integer data types. This conversion may facilitate a reduction in model size and shorten inference time. Although there is a decrease in accuracy, the decrease may not be substantial.

Quantization may diminish memory footprint because lower-precision data types, such as 8-bit and 6-bit integers, may specify significantly less storage space compared to the higher precision of 32-bit floating-point representations. Additionally, this transition may result in accelerated computational speeds.

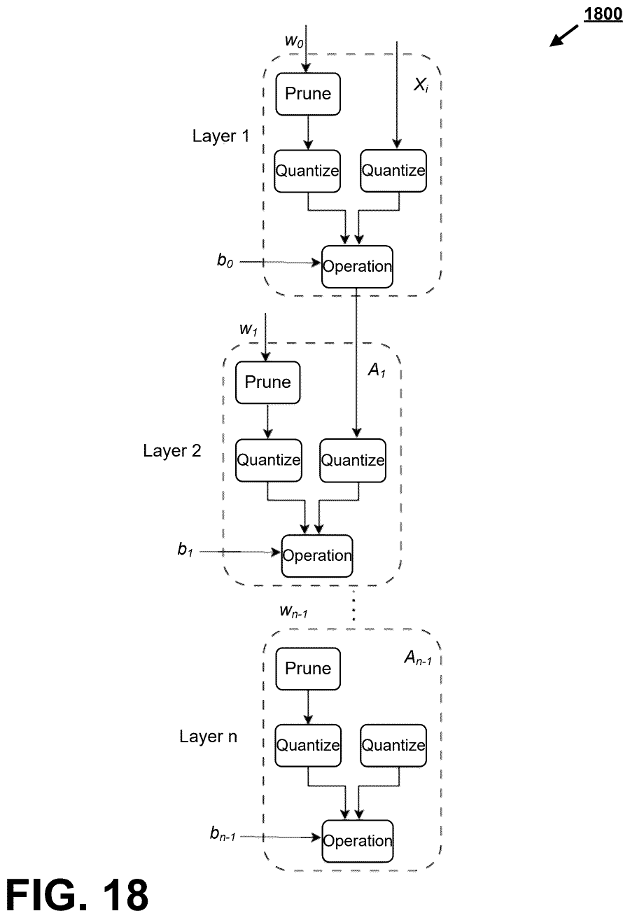

FIG. 18 depicts a flow diagram of example pruning-quantization 1800 in accordance with some embodiments of the present disclosure. Quantization with pruning may be implemented to train deep neural networks using uniform quantization and unstructured pruning on both weights and activations. A prune-then-quantize framework may be used for the weights of a first layer and quantization may be applied to activations of the first layer. In a following layer, the prune-then-quantize framework may be applied to both the weights and the activations. By using such a technique, the following may be achieved:

Model Size Reduction: The application of combined pruning and quantization may significantly reduce model size. Pruning may eliminate superfluous weights and activations, curtailing their updates during both training and inference phases. Concurrently, quantization may decrease the precision of remaining weights and activations, further streamlining a model. The dual approach may enhance a model's efficiency by minimizing its computational and storage demands.

Enhanced Inference Speed: A combination of fewer parameters (pruning) and lower precision operations (quantization) may lead to significant improvement in inferencing speed.

Speed Optimization During Inferencing: Upon completion of training in a higher precision format (such as FP64/32), a model may be stored. Subsequently, the stored model may be loaded and its weights may be converted to lower precision types, such as INT16 or INT8, to reduce memory footprint via quantization. The most frequently occurring weights and activations may be stored in a pre-compute storage memory (e.g., LUT/SRAM/CAM) that is integrated with PENN. Pre-computed data may be utilized to save computational time and to reduce MAC utilization.

Speed Optimization During Training: Training may be conducted utilizing both software and hardware platforms. Within the software environment, an implementation of PENN may facilitate pre-computation and storage of values that exhibit the highest frequency over designated epochs. Subsequently, the pre-computed and stored values may be accessed and utilized during a training process. This approach may effectively reduce computational burden associated with multiplications and additions. Accordingly, speed optimization during training may enhance the efficiency of the training phase by decreasing computational overhead.

Following the transformation of data from high-precision formats, such as FP64, FP32, and FP16, to lower-precision representations, such as INT16, INT8, INT6, and INT4, a frequency distribution of weights may be analyzed. Subsequent to this analysis, certain lower significance bits may be aggregated, resulting in the clipping of data to specific values within a designated range. Such aggregation may also be referred to as “reconfigurable sizing” and allows for the resizing and adjustment of data points to configurable parameters, thereby enhancing the efficiency of data management.

For instance, weight values of “16,” “17,” and “18” may be uniformly adjusted to “17,” while values of “−21,” “−22,” and “−23” are standardized to “−22.” The aforementioned method opts for a median value within a selected data segment, thereby effectively consolidating weights and consequently diminishing overall storage requirement. Such a reduction may reduce the space occupied in a pre-compute storage memory (e.g., LUT/SRAM/CAM) and may also contract the search space involved. A reduction in space may further translate into decreased computational requirements.

Pruning and quantization techniques may significantly enhance energy efficiency and performance of configurable SRAM and CAM-based neural networks, especially in resource-constrained applications. Pruning unnecessary weights and activations may reduce storage requirements, while quantizing weights and activations to lower precision may minimize memory usage and computational power. Combining pruning and quantization may lead to lower energy consumption and faster inference times. Custom memory controllers may dynamically manage pruned and quantized data, thereby optimizing memory configurations for different operational phases. Integrating such techniques into configurable SRAM and CAM may result in notable improvements in memory efficiency, energy consumption, and overall performance.

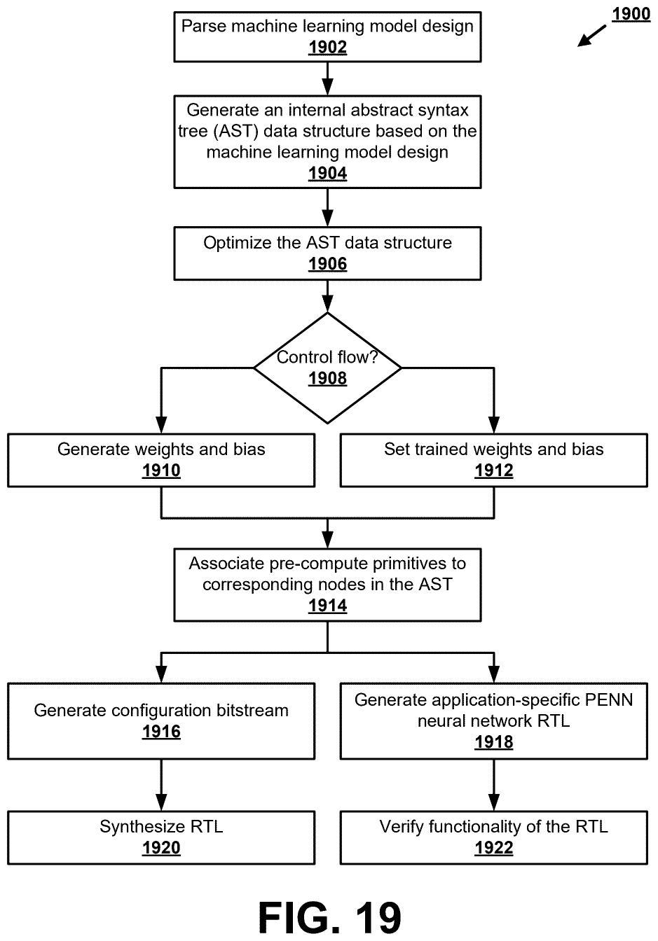

FIG. 19 is a flowchart of an example hardware design process 1900 in accordance with some embodiments of the present disclosure.

In some embodiments, the process 1900 begins at step/operation 1902 when a computing system (e.g., based on a PENN framework) receives a target machine learning model design (e.g., designed in the software phase). The target machine learning model design may be parsed via a custom parser or any open source tool, such as Open Neural Network Exchange (ONNX), and generate a dump.

In some embodiments, at step/operation 1904, the computing system generates an internal AST data structure based on the machine learning model design (e.g., by reading the dump).

In some embodiments, at step/operation 1906, the computing system applies one or more PENN optimizations to the AST data structure (e.g., pruning, quantization (e.g., INT6, INT8, etc.), pruning and quantization, or selective quantization) to the nodes of the ASY data structure to reduce the footprint of the AST and increase energy efficiency.

In some embodiments, at step/operation 1908, the computing system determines a type of control flow of FSM for a PENN accelerator.

In some embodiments, at step/operation 1910, the computing system generates weights and biases for a control flow that supports both on-device training and inferencing. In some embodiments, random weights and biases may be generated for training a machine learning model, and during inferencing, the trained weights may be selected (or if training is performed in software, then software trained weights may be selected) and associated with nodes in the AST data structure.

In some embodiments, at step/operation 1912, the computing system sets weights and biases for a control flow that supports on-device inferencing where a machine learning model may be trained during a software design phase. Weights and biases from the designed target machine learning model may be associated with the respective nodes in the AST data structure.

In some embodiments, at step/operation 1914, the computing system one or more pre-compute primitives, such as SRAM/CAM modules, are associated to various PENN primitive nodes (e.g., PENN neuron, layer and full neural network) in the AST data structure.

In some embodiments, at step/operation 1916, the computing system generates a configuration bitstream.

In some embodiments, at step/operation 1918, the computing system generates application-specific PENN RTL.

In some embodiments, at step/operation 1920, the computing system checks for correctness of the generated RTL in a verification setup.

In some embodiments, at step/operation 1922, post verification of the RTL, the computing system synthesizes the RTL to a target design library for fabrication as a PENN accelerator.

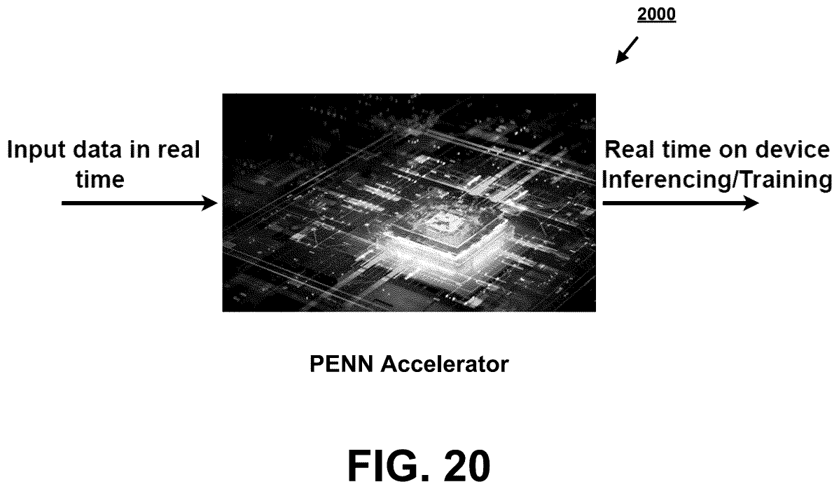

FIG. 20 is an example PENN accelerator 2000 in accordance with some embodiments of the present disclosure. Post fabrication, the PENN accelerator 2000 may be deployed in the field. The PENN accelerator 2000 may be configured to receive input data in real time and perform real time on-device inferencing and/or training.

### Example PENN Framework Implementations

According to various embodiments of the present disclosure, a PENN framework may comprise a CAM-based implementation, a SRAM-based implementation, a LUT-based implementation, or a hybrid (LUT/SRAM/CAM) implementation.

### CAM-Based Implementation

A neuron of a neural network may comprise three input components and one output component. For example, the input components may comprise an activation matrix, a weight matrix, and a bias for the neuron. To obtain the output component of the neuron, the activation matrix may be multiplied to the weight matrix and to which the bias is added. A resulting intermediate value may then be passed as input to an activation function that is specific to the neuron. The output of the activation function may comprise a final output of the neuron.

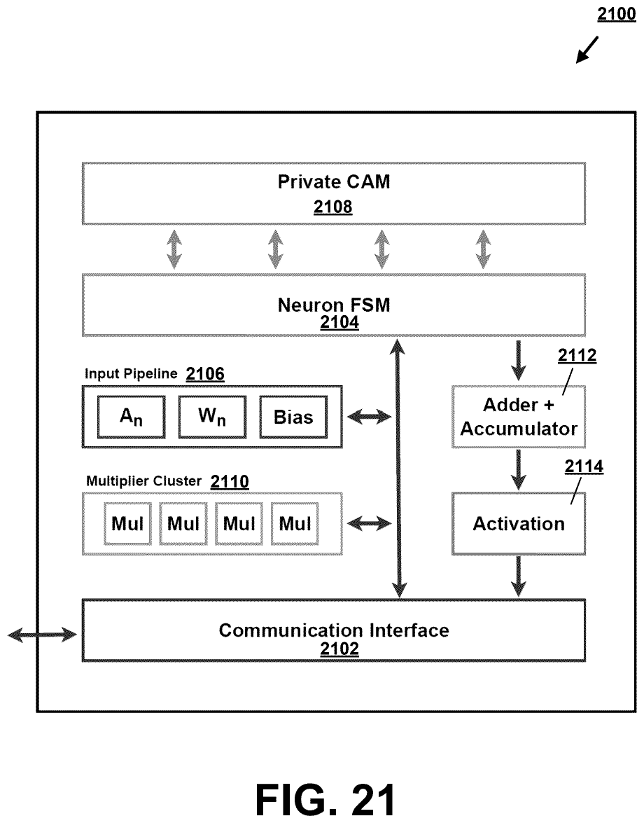

FIG. 21 is a schematic of an example CAM-based PENN neuron 2100 in accordance with some embodiments of the present disclosure. The size of input vectors may be substantially large in traditional neural networks and it may not be possible to create every primitive in hardware. However, the CAM-based PENN neuron 2100 depicted in FIG. 21 may support a substantial and/or arbitrary number of input vectors without incurring ballooning overheads.

The CAM-based PENN neuron 2100 comprises a communication interface 2102, a neuron FSM 2104, an input pipeline 2106, a private CAM (4 ported) 2108, a multiplier cluster 2110, an adder and accumulator 2112, and an activation function 2114. The communication interface 2102 may be configured to provide an input pipeline 2106 comprising an activation matrix (Aₙ), a weight matrix (Wₙ), and a bias. The communication interface 2102 may also be configured to transmit an output of the activation function 2114 for the PENN neuron. The multiplier cluster 2110 may comprise one or more multiplier units (Mul) that are used for performing multiplication of the weight (Wₙ) and activation (Aₙ) matrices.

The neuron FSM 2104 may be configured to search the private CAM 2108 and/or schedule and fill the input pipeline 2106 for the multiplier cluster 2110. As disclosed herewith, the CAM-based PENN neuron 2100 may save energy by re-utilizing pre-computed values, as operations, such as multiplication, consume a substantial amount of energy. In some embodiments, pre-computed values may be stored and retrieved from the private CAM 2108 to avoid recalculating values. In some embodiments, the neuron FSM 2104 may be configured to determine if a specific multiplication operation has been previously performed before by querying a table of the private CAM 2108.

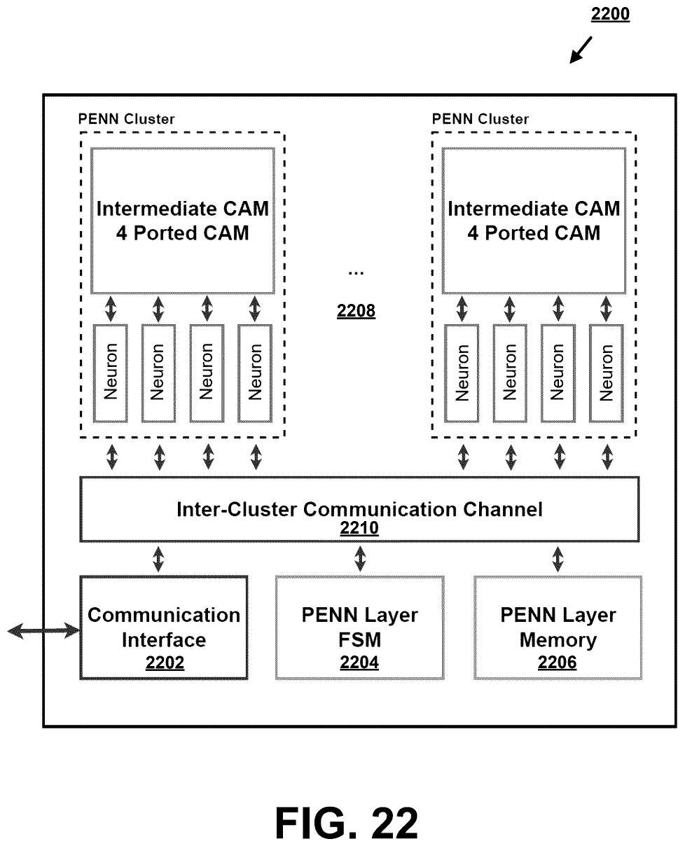

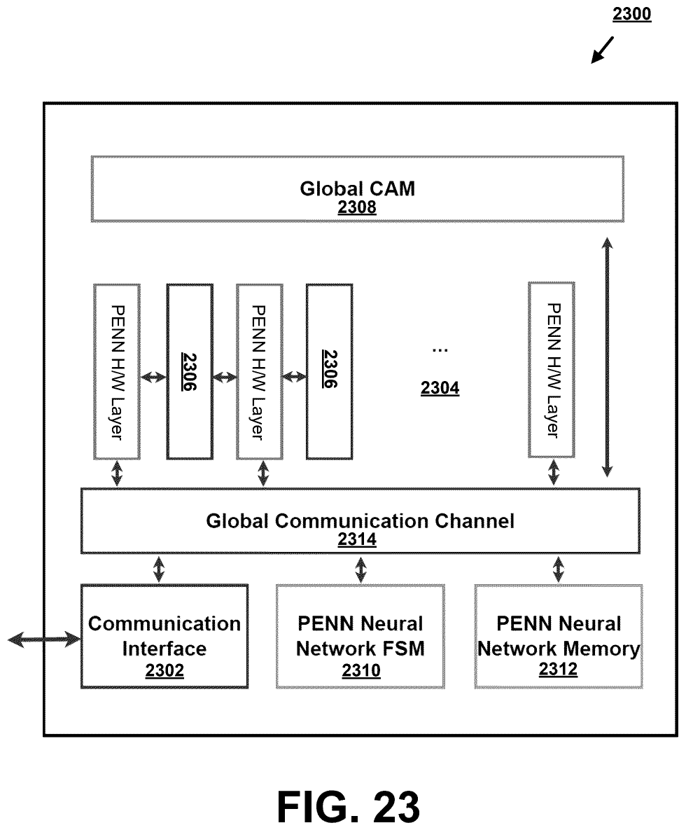

In some embodiments, if a specific multiplication operation is not present in CAM-based PENN neuron 2100, the neuron FSM may query tables of its cluster CAM (e.g., from FIG. 22) and/or its global CAM (e.g., from FIG. 23). If a specific multiplication operation is not present in any of the CAM tables, the multiplication operation may be scheduled in a pipeline of the multiplier cluster 2110. In some embodiments, the neuron FSM 2104 may pass multiplication values (either computed or retrieved from CAM) to the adder and accumulator 2112. In some embodiments, multiplication values that have been added and/or accumulated may be provided to the activation function 2114, which may generate output that is passed on to the communication interface 2102 to be available as input to neurons in a next layer.

A software neural network layer may comprise one or more neurons and two types of connectivity. A first type may comprise a fully connected neuron that receives all activations from neurons of a previous layer. A second type may comprise a partially connected neuron that takes into account output of less than an entirety of neurons of a previous layer.

FIG. 22 is a schematic of an example CAM-based PENN layer 2200 based on a CAM implementation in accordance with some embodiments of the present disclosure. The CAM-based PENN layer 2200 comprises a communication interface 2202, a PENN layer FSM 2204, PENN layer memory 2206, a plurality of PENN clusters 2208 (each of which comprises four PENN neurons and an intermediate CAM (4 ported)), and an inter-cluster communication channel 2210. The communication interface 2202 may be configured to receive all of raw data to be processed by the plurality of PENN clusters 2208 and transmit the processed data. Because of a high probability that neurons that are located spatially close to each other may operate on similar values, PENN neurons may be clustered in a group and attached to an intermediate CAM. As such, each PENN neuron may access a private cluster CAM for re-using computations before proceeding to compute values. The PENN layer memory 2206 may be configured to store (i) raw input data to be processed by the plurality of PENN clusters 2208 and (ii) the processed data from the plurality of PENN clusters 2208. The PENN layer FSM 2204 may be configured to (i) fetch, store, and offload the processed data via the inter-cluster communication channel 2210 and (ii) schedule the data needs of the PENN clusters 2208.

FIG. 23 is a schematic of an example CAM-based PENN neural network 2300 based on a CAM implementation in accordance with some embodiments of the present disclosure. The CAM-based PENN neural network 2300 may be associated with (or representative of) a software neural network that comprises a plurality of layers including neurons that are connected in a back-to-back fashion. The CAM-based PENN neural network 2300 comprises a communication interface 2302, a plurality of PENN hardware layers 2304 connected back-to-back via PENN interlayer channels 2306, a global CAM 2308, a PENN neural network FSM 2310, and PENN neural network memory 2312. The communication interface 2302 may be configured to communicate with an outside environment and transmit data to and from the CAM-based PENN neural network 2300. A global communication channel 2314 facilitates communication between the communication interface 2302, the plurality of PENN hardware layers 2304, the global CAM 2308, the PENN neural network FSM 2310, and the PENN neural network memory 2312. In some embodiments, the global communication channel 2314 may also be configured to communicate with a host (e.g., software, cloud, FPGA, GPU, etc.).

The PENN neural network FSM 2310 may be configured to load and/or unload the PENN neural network memory 2312 and the plurality of PENN hardware layers 2304. The PENN neural network memory 2312 may be configured to store (i) raw data to be supplied to the plurality of PENN hardware layers 2304 and (ii) the processed data of a final hardware layer. The plurality of PENN hardware layers 2304 may also be configured to communicate with the global CAM 2308 to determine if any pre-computed values may be used, if present.

### Associative Memoryless-Based Implementation

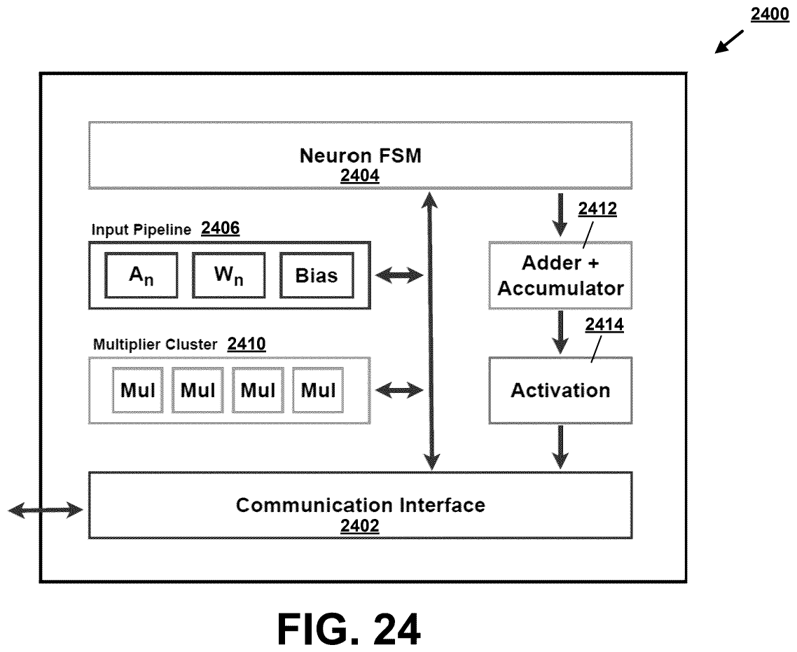

FIG. 24 is a schematic of an example associative memoryless PENN neuron 2400 in accordance with some embodiments of the present disclosure. The associative memoryless PENN neuron 2400 comprises a communication interface 2402, a neuron FSM 2404, an input pipeline 2406, a multiplier cluster 2410, an adder and accumulator 2412, and an activation function 2414. The associative memoryless PENN neuron 2400 may exclude an associative memory, such as a private CAM (e.g., 2108) or a SRAM table, and instead interfaces with a layer and/or global pre-compute storage block. As such, the associative memoryless PENN neuron 2400 may lack an associative memory but yet still may comprise identical or substantially similar functionality as the aforementioned CAM-based PENN neuron 2100 in FIG. 21.

### LUT-Based Implementation

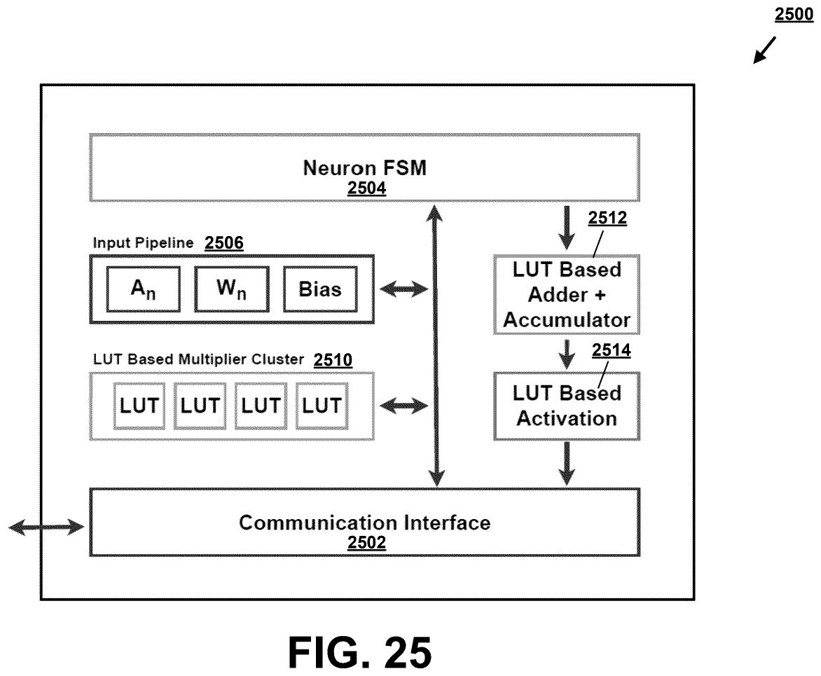

FIG. 25 is a schematic of an example LUT-based PENN neuron 2500 based on a LUT implementation in accordance with some embodiments of the present disclosure. As depicted in FIG. 25, the LUT-based PENN neuron 2500 comprises LUTs in place of computing elements. LUT-based PENN neuron 2500 comprises a communication interface 2502, a neuron FSM 2504, an input pipeline 2506, a LUT-based multiplier cluster 2510, a LUT-based adder and accumulator 2512, and a LUT-based activation function 2514. The LUT-based PENN neuron 2500 may be configured to pre-calculate values of computing elements, such as adders via LUT-based adder and accumulator 2512, multipliers via LUT-based multiplier cluster 2510, and activation units via LUT-based activation function 2514, and generate associated truth tables. The LUT-based multiplier cluster 2510, LUT-based adder and accumulator 2512, and LUT-based activation function 2514 may be programmed with the truth tables to perform computing operations. An advantage of LUT-based computing elements may comprise the generation of computation results in one clock cycle based on computations retrieved from LUTs. However, a downside of a LUT-based implementation may comprise a loss in precision of output results as it may not be feasible to store all possible output values in a LUT. To increase precision, larger LUTs may be implemented but may in turn increase overhead of the LUT-based PENN neuron 2500.

### SRAM-Based Implementation

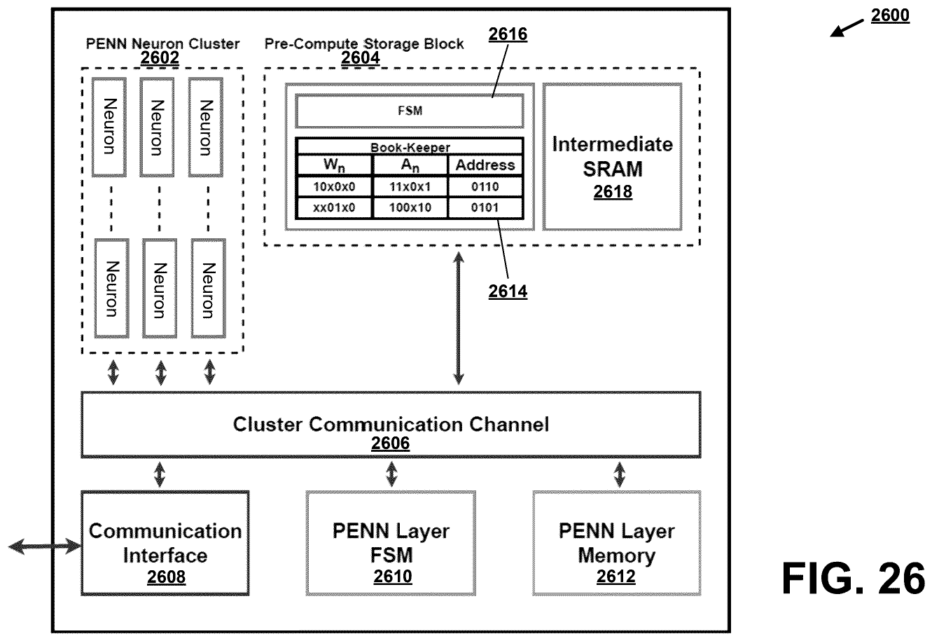

FIG. 26 is a schematic of an example SRAM-based PENN layer 2600 in accordance with some embodiments of the present disclosure. The SRAM-based PENN layer 2600 comprises a PENN neuron cluster 2602 that comprises hardware neurons, a pre-compute storage block 2604, a cluster communication channel 2606, a communication interface 2608, a PENN layer FSM 2610, and PENN layer memory 2612. PENN neurons in the PENN neuron cluster 2602 may be grouped together in a single cluster for achieving increased energy conservation. The SRAM-based PENN layer 2600 may prioritize energy efficiency over speed by locating every neuron in a single cluster and the cluster may communicate with the pre-compute storage block 2604.

The pre-compute storage block 2604 may comprise a book-keeper element 2614 and an intermediate SRAM block 2618. The intermediate SRAM block 2618 may comprise a monolithic SRAM array that is configured to store a plurality of pre-computed values. When a neuron encounters a particular activation with its associated weight, the neuron may query the book-keeper element 2614 with arguments based thereof. If the arguments are contained within the book-keeper element 2614, the book-keeper element 2614 may provide an address at which a pre-computed value is located in the pre-compute storage block 2604. An FSM 2616 of the pre-compute storage block 2604 may then proceed to retrieve and provide the pre-computed value to the neuron which initiated the request. If a pre-computed value is not present, the neuron may proceed with actually computing values within the neuron's multiplier cluster. The neuron may pass computed values to the pre-compute storage block 2604 so that the computed values may be stored for future retrieval and use.

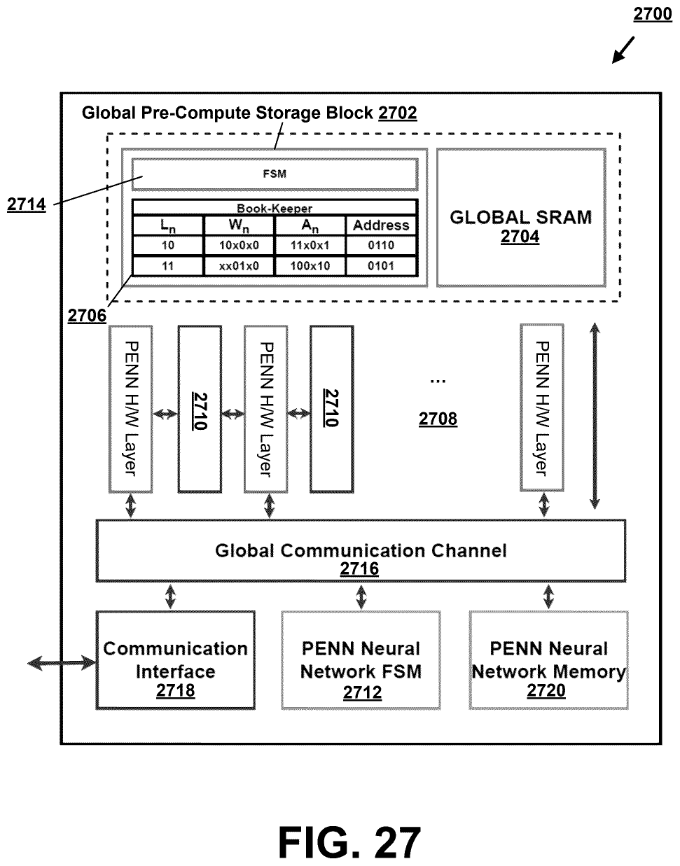

FIG. 27 is a schematic of an example SRAM-based PENN neural network 2700 in accordance with some embodiments of the present disclosure. The SRAM-based PENN neural network 2700 comprises a global pre-compute storage block 2702 that includes a global SRAM module 2704 and a book-keeper element 2706. The global SRAM module 2704 may either be monolithic or may comprise a plurality of distributed memory banks. Monolithic memory may be suited for a more energy-conservative device while a distributed memory bank may be faster and consume relatively more power, which may be suited for a device targeted towards performance efficiency. A distributed memory bank may be able to service more requests per clock cycle and hence enhance performance but at the cost of higher energy consumption.

The SRAM-based PENN neural network 2700 further comprises a plurality of PENN hardware layers 2708 that are connected back-to-back via PENN interlayer channels 2710. The SRAM-based PENN neural network 2700 may serve an arbitrary number of neural network layers, and as such, an entirety of the SRAM-based PENN neural network 2700 may not be fabricated at the same time. For example, after a first set of software layers are computed on the hardware layers, a next set of software layers may be mapped to the same hardware layers. Such a process may help support an arbitrary number of software layers without being constrained by hardware. A process of loading and unloading the function of software layers onto the hardware layer may be handled by the PENN neural network FSM 2712.

When hardware layers are processing input data, the PENN neural network FSM 2712 may query the global pre-compute storage block 2702 with three input argument unlike with two input arguments in a PENN hardware layer. In some embodiments, the arguments may be represented by a layer id Lₙ, its associated weight Wₙ, and an associated activation Aₙ. Input arguments may be passed on to the book-keeper element 2706 in the global pre-compute storage block 2702. If the input arguments are present, the book-keeper element 2706 may provide an associated address at which a pre-computed value is present in global SRAM module 2704. A global pre-compute block FSM 2714 may be configured to fetch and supply the value to the associated PENN hardware layer.

The global communication channel 2716 may be configured to handle traffic related to service requests between the PENN hardware layers 2708 and the global pre-compute storage block 2702. The global communication channel 2716 may also be configured to handle data traffic between a communication interface 2718 that interfaces with devices from an outside environment (e.g., software, cloud, FPGA, GPU, etc.), the PENN neural network FSM 2712, and a PENN neural network memory 2720.

A PENN interlayer channel 2710 may be configured to handle data transmissions between the PENN hardware layers 2708, such as data traversal during inferencing or training of the SRAM-based PENN neural network 2700. The PENN neural network memory 2720 may be configured to store raw input data received from the outside environment, weights and biases associated with PENN hardware layers 2708, intermediate data that may be stored when a software layer changes to a next set of software layers, and processed output of operations performed on a mapped neural network. In some example embodiments, a batch of input data may run on each mapping of a software layer onto hardware layers to gain maximum efficiency.

It may be taken into consideration that if a target AI model is too big, it may not be feasible to fabricate a complete neural network fabric. To remedy the situation, hardware neuron (e.g., PENN neuron) may be disassociated from the software neuron. It may be noted that a hardware neuron may be a data resolution point for a software neuron and may not be hard mapped to its software counterpart. In the condition of scarcity of resources, a hardware neuron may be able to resolve a plurality of software counterparts. In a similar scenario, when due to resource constraints, if enough PENN layers cannot be fabricated, a PENN hardware layer may be disassociated from its software counterpart. In the condition of resource scarcity, a PENN hardware layer may be a data resolution point for a plurality of software layers, where the PENN hardware layer may be shared in time by a plurality of software layers. To facilitate such functionality, an entirety of a PENN architecture may be divided into three levels of hierarchy, namely the (i) PENN neuron, the lowest functional unit of the PENN architecture, (ii) PENN layers, comprising a plurality of PENN neurons, and (iii) the global PENN architecture that consists of the several PENN Layers.

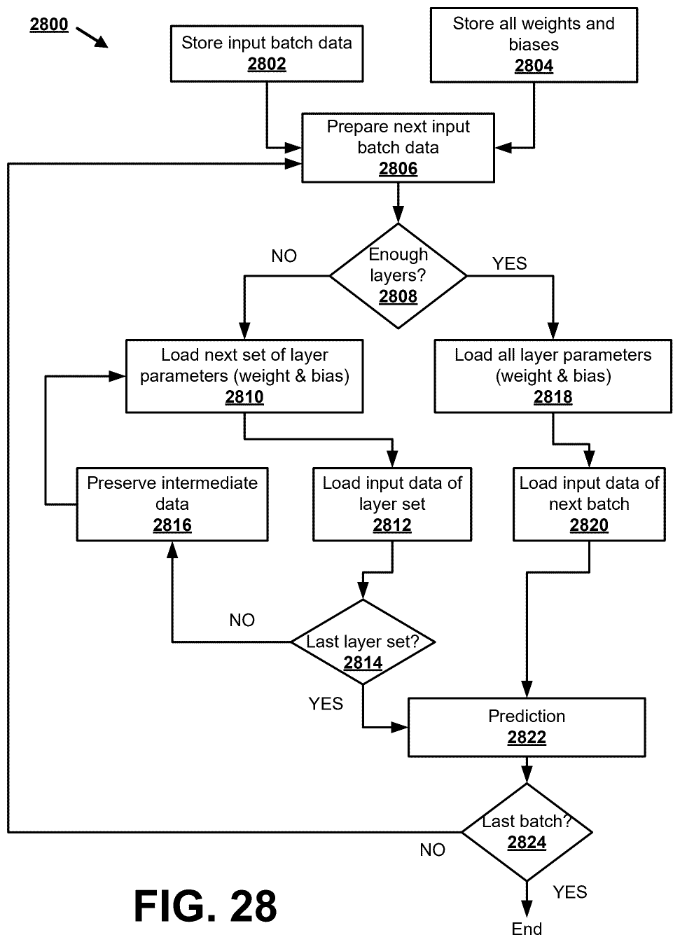

FIG. 28 is a flowchart of an example global PENN state transition process 2800 in accordance with some embodiments of the present disclosure.

In some embodiments, the process 2800 begins at step/operation 2802 when a computing system stores input batch data.

In some embodiments, the process 2800 also begins at step/operation 2804 when the computing system stores all weights and biases.

In some embodiments, at step/operation 2806, the computing system prepares next input batch data.

In some embodiments, at step/operation 2808, the computing system determines if there are enough layers.

In some embodiments, at step/operation 2810, if there are not enough layers the computing system loads a next set of layer parameters (weight and biases).

In some embodiments, at step/operation 2812, the computing system loads input data of the layer set.

In some embodiments, at step/operation 2814, the computing system determines if the layer set is the last layer set.

In some embodiments, at step/operation 2816, if the layer set is not the last layer set, the computing system preserves intermediate data, and the process returns to step/operation 2810.

In some embodiments, at step/operation 2822, the computing system generates a prediction based on the loaded input data.

In some embodiments, at step/operation 2818, if there are enough layers (step/operation 2808), the computing system loads all layer parameters (weight & biases).

In some embodiments, at step/operation 2820, the computing system loads input data of a next batch.

In some embodiments, at step/operation 2824, the computing system determines whether a current batch is the last batch. In some embodiments, if the current batch is not the last batch, the process 2800 returns to step/operation 2806. If the current batch is the last batch, the process 2800 ends.

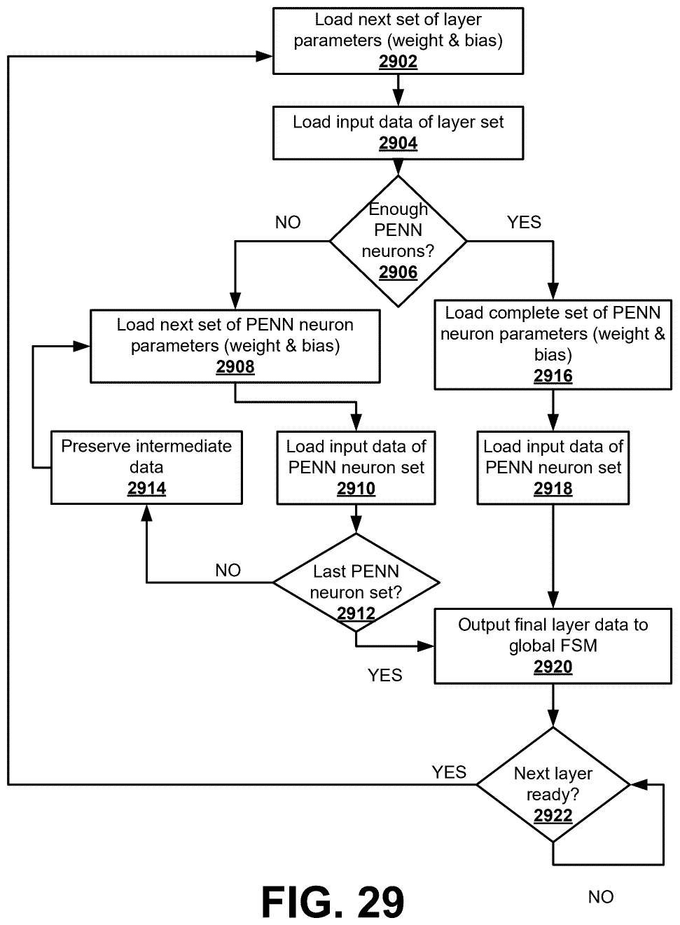

FIG. 29 is a flowchart of an example PENN layer state machine state transition process 2900 in accordance with some embodiments of the present disclosure.

In some embodiments, the process 2900 begins at step/operation 2902 when a computing system loads a next set of layer parameters (weight and bias).

In some embodiments, at step/operation 2904, the computing system loads input data of layer set.

In some embodiments, at step/operation 2906, the computing system determines whether there are enough PENN neurons.

In some embodiments, at step/operation 2908, if there are not enough PENN neurons, the computing system loads a next set of PENN neuron parameters (weight and bias).

In some embodiments, at step/operation 2910, the computing system loads input data of the PENN neuron set.

In some embodiments, at step/operation 2912, the computing system determines whether the PENN neuron set is the last PENN neuron set.

In some embodiments, at step/operation 2914, if the PENN neuron set is not the last PENN neuron set, the computing system preserves immediate data and the process 2900 proceeds to step/operation 2908.

In some embodiments, at step/operation 2920, if the PENN neuron set is the last PENN neuron set, the computing system outputs the final layer data to a global FSM.

In some embodiments, at step/operation 2916, if there are enough PENN neurons (step/operation 2906), the computing system loads a complete set of PENN neuron parameters (weight and bias).

In some embodiments, at step/operation 2918, the computing system loads input data of the PENN neuron set.

In some embodiments, at step/operation 2920, the computing system outputs the final layer data to a global FSM.

In some embodiments, at step/operation 2922, the computing system determines whether the next layer is ready. In some embodiments, if the next layer is ready, the process 2900 returns to step/operation 2902.

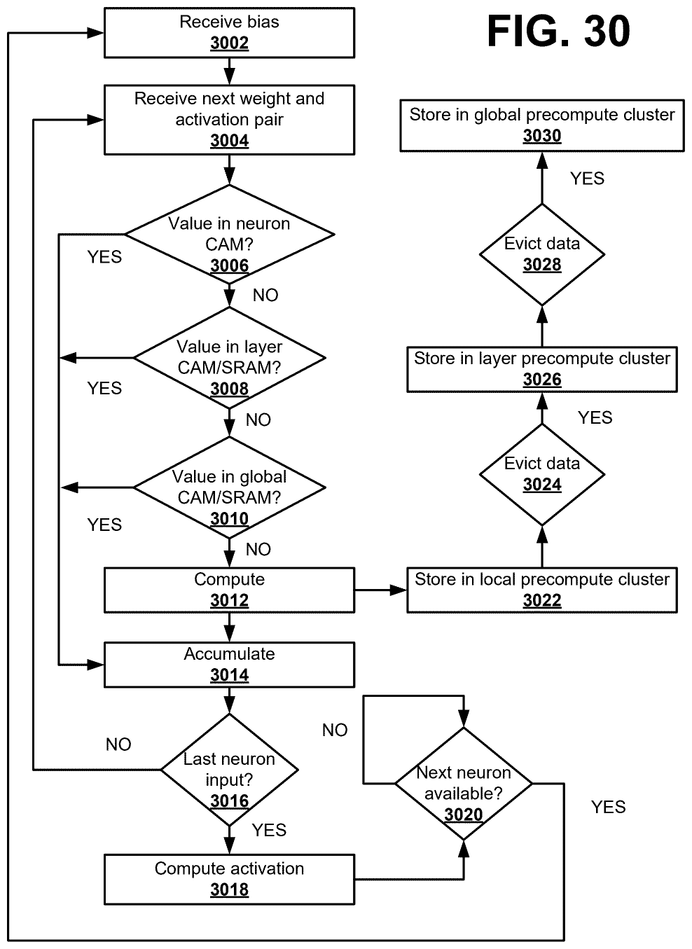

FIG. 30 is a flowchart of an example PENN neuron state machine state transition process 3000 in accordance with some embodiments of the present disclosure.

In some embodiments, the process 3000 begins at step/operation 3002 when a computing system receives a bias.

In some embodiments, at step/operation 3004, the computing system receives a next weight and activation pair.

In some embodiments, at step/operation 3006, the computing system determines whether the next weight and activation pair corresponds to a value stored in a neuron CAM.

In some embodiments, at step/operation 3008, the computing system determines whether the next weight and activation pair corresponds to a value stored in a layer CAM/SRAM.

In some embodiments, at step/operation 3010, the computing system determines whether the next weight and activation pair corresponds to a value stored in a global CAM/SRAM.

In some embodiments, at step/operation 3012, if the next weight and activation pair do not correspond to any value in any of the neuron CAM, layer CAM/SRAM, or global CAM/SRAM, the computing system computes the next weight and activation pair.

In some embodiments, at step/operation 3022, the computing system stores a computed value corresponding to the next weight and activation pair to a local precompute cluster.

In some embodiments, at step/operation 3024, the computing system determines whether to evict the computed value.

In some embodiments, at step/operation 3026, the computing system stores the computed value corresponding to the next weight and activation pair to a layer precompute cluster.

In some embodiments, at step/operation 3028, the computing system determines whether to evict the computed value.

In some embodiments, at step/operation 3030, the computing system stores the computed value corresponding to the next weight and activation pair to a global precompute cluster.

In some embodiments, at step/operation 3014, if the next weight and activation pair correspond to any value in any of the neuron CAM, layer CAM/SRAM, or global CAM/SRAM, the computing system accumulates value(s) from the neuron CAM, layer CAM/SRAM, or global CAM/SRAM.

In some embodiments, at step/operation 3016, the computing system determines whether the weight and activation pair comprise a last neuron input. If the weight and activation pair do not comprise a last neuron input, the process 3000 proceeds to step/operation 3004.

In some embodiments, at step/operation 3018, if the weight and activation pair comprise a last neuron input, the computing system computes an activation.

In some embodiments, at step/operation 3020, the computing system determines whether a next neuron is available. If a next neuron is available, the process 3000 proceeds to step/operation 3002.

As discussed in previous sections, various techniques, such as pruning and quantization, may be employed to reduce energy consumption as well as enable fast operations. However, a downside of such operations may comprise a drop in accuracy. Based on given loss tolerances within an acceptable margin, optimizations may be performed when PENN hardware is synthesized by the PENN framework for a relatively simpler PENN hardware, or during hardware runtime, dynamically, both during inferencing and training phases occurring in situ on hardware with the cost of a relatively more complex control FSMs of different PENN hardware primitives. Irrespective of how optimizations are performed, the optimizations may affect the size of the input and output of the data primitives used in the process. Most modern memory systems are byte-addressable, and the smallest unit of data may be 1 byte or 8 bits of data, and each of these bytes may be assigned an address. For example, a memory primitive (CAM/SRAM) that has a word size of 4 bytes and a depth of 8 words and the smallest data primitive is also 1 byte in size. Due to optimizations, removing 2 bits from the smallest data primitive may result in its effective size becoming 6 bits and 8 bits of unused data at each level of memory. To achieve maximum utilization of resources, the memory primitive controller may dynamically change the smallest unit of data from 8 bits to 6 bits, allowing for 5 smallest units of data (6 bits each) at each level of the memory primitive instead of an initial 4. As such, more data primitives may be stored in the same storage element than possible without optimization.

In some embodiments, an additional control unit may be employed to dynamically reconfigure the smallest unit of data. Read/write memory accesses may account for an entire row/word (4 bytes); thereby row access may not be modified. However, to ensure dynamic programmability, a word itself may be either (i) bit-addressable, comprising individual control for each bit, increasing the complexity of a multiplexer (MUX) control logic from 2-bits to 5-bits along with an access latency that is proportional to a bit-width of a smallest unit of data; or (ii) unit-addressable, wherein the bit-width of a smallest unit of data may be accessed from within the word at a time, which may specify an additional 3-bit binary to thermometer converter (negligible overhead). The MUX control logic may be made 5-bit (for scenarios when individual bit accesses may be specified, for example, for a binary neural network). However, the data access latency may remain constant at 1 cycle, similar to original fixed bit-width implementations.

In some embodiments, communicating with outside-environment devices may comprise upscaling the aforementioned data units to their former standard of byte-addressable data. In some embodiments, upscaling may comprise padding a target number of zeros to the most significant bit (MSB) (e.g., 2 zeros).

In some embodiments, a hybrid architecture may provide dynamic programmability of example memory primitives. For example, upscaling may be performed at the boundary of PENN hardware or at an interface which facilitates communication with a host device.

The disclosed PENN framework may be used for various applications in various domains and industries, where energy efficiency, low-latency inference, and privacy may be important. CAM- or SRAM-based PENN may provide significant benefits on device training, such as improved energy efficiency, faster inference speeds, cost savings, or scalability. The disclosed PENN may provide low memory footprint, low power-based neural network-based accelerators.

### Example Applications and Impacts

The following describes various example application domains and potential impact.

Energy Efficiency: CAM/SRAM-based PENN may provide energy efficiency in neural network training and inferencing. By optimizing memory footprint and reducing repeated computations, the disclosed PENN framework may significantly lower energy consumption of AI systems and increase sustainability and/or cost-effectiveness to operate.

Hardware Reduction: PENN implemented with CAM/SRAM may be used to develop compact and lightweight neural network models. Performing pruning and quantization, as disclosed herewith, may also result in compact neural network models. Hardware specifications for deploying AI systems may also be reduced, thereby rendering AI systems more accessible and feasible for resource constrained devices, such as edge devices, IoT devices, and mobile and/or smart devices.

High speed Inference: The disclosed PENN framework may enhance inference speed by reducing memory access latency and computational overhead. For example, the disclosed PENN framework may improve response time for AI applications, such as image recognition, natural language processing, and sensor data analysis, thereby enhancing user experiences and real-time performance.

Scalability and Flexibility: The disclosed PENN framework may facilitate efficient scaling of AI systems across diverse hardware platforms and deployment scenarios. Optimized models for energy efficiency may be deployed on various devices without performance compromise, offering flexible deployment options and scalability.

On Device Training: The disclosed PENN framework may provide reduced energy consumption and reduced memory footprint to enable efficient on-device training of a neural network that may be integrated with resource-constrained devices.

Cost Efficiency: Energy-efficient AI systems facilitated by the disclosed PENN framework may provide cost efficiency for organizations by consuming less energy, reducing hardware needs, and lowering operational expenses related to AI infrastructure. Accordingly, long-term economic viability and sustainability of AI adoption may be enhanced.

New AI Integration: A CAM/SRAM-based energy efficient approach, as disclosed herewith, may provide new AI applications in various fields, such as edge computing, Internet-of-Things (IoT), healthcare, autonomous systems, smart cities, and environmental monitoring. As such, innovative solutions that may be restricted in the past by energy limitations may be enabled.

According to various embodiments of the present disclosure, quantization and pruning may both be used in neural network optimization. A neural network model may be coded in software while writing code in the software using pruning and/or quantization. During training, weight updates may be pruned, for example when a gradient magnitude stabilizes, thereby indicating that the magnitude of weight updates may not exhibit significant variations. In some embodiments, the input and weight multiplications may be determined to generate a frequency distribution.

Based on the top frequency, most frequently appearing input pairs may be stored along with calculated values that respectively correspond to the input pairs in the CAM. A neural network model may be stored and subsequently trained. By following the disclosed techniques, the overall computation of multiplications may be saved. Thus, a total size of the neural network may also reduce computation costs.

During forward pass, a model's weights and activations may be quantized to lower precision (e.g., 8-bit integers) as they would be during inference. However, during the backward pass, the gradients may be computed using full precision values to avoid loss of information. A training process may adjust the weights to minimize the errors introduced by quantization, allowing the model to learn to be more robust to the reduced precision.

A model may often be pre-trained with full precision and then fine-tuned with QAT to refine the weights under quantization effects. Quantization-Aware Training (QAT) may quantize during training, allowing a model to learn and adapt to a reduced precision.

According to various embodiments of the present disclosure, a PENN may be used in diverse applications across industries and government bodies. Stakeholders, such as AI chip makers, cloud providers, cybersecurity solution providers, healthcare and remote monitoring systems, IoT and edge devices, autonomous systems, and government agencies comprise potential stakeholders for implementing the disclosed PENN effectively. Main key application areas may include:

AI Chip Manufacturers: AI chip manufacturers may design and produce AI chips that power various technologies. AI chip manufacturers may also use the disclosed PENN framework to ensure products are used responsibly and securely across industries. The scheme may provide guidelines for manufacturing practices, security features to be included in the chips, and regulations for usage to prevent misuse.

Mobile Devices: Manufacturers of mobile devices may integrate the disclosed PENN to provide robust energy-efficient AI capabilities that minimize battery power drain, which may be important for applications in smartphones, tablets, and/or other portable electronics where power efficiency may translate directly into longer device usability.

Wearable Technology: Companies in the wearable sector may utilize the disclosed PENN to reduce energy consumption of devices, such as smartwatches, fitness trackers, and health monitors. Accordingly, more complex AI tasks may be performed directly on such devices without frequent recharging.

Automotive Industry: Automotive manufacturers may apply the disclosed PENN in driver-assistance systems and autonomous vehicles. By reducing energy demands of on-board AI systems, manufacturers may optimize power consumption across a vehicle's electronic systems, improving overall efficiency and performance.

Drone Technology: The disclosed PENN may be beneficial in the drone industry where power efficiency is linked to flight duration and operational capacity. Efficient neural network computing may allow for longer missions and more complex processing tasks while airborne.

Smart Home Devices: In the realm of IoT, smart home device manufacturers may use the disclosed PENN to improve the efficiency of AI-driven features in products, such as security cameras and voice-activated assistants.

Healthcare Monitoring: Medical device manufacturers may implement the disclosed PENN in portable diagnostic and monitoring equipment. In some embodiments, energy-efficient AI processing may support longer use in critical patient monitoring systems without compromising a desired computational accuracy for healthcare applications.

Environmental Monitoring: The disclosed PENN may be utilized in environmental sensors and monitoring systems to perform complex computations for longer periods without frequent battery changes, which may be important in remote or logistically challenging locations.

Edge Computing: The disclosed PENN may be ideal for edge computing applications where data is processed locally on hardware that is limited by power consumption and computational capabilities. Various industries may be benefited, such as manufacturing and logistics, by enabling more sophisticated processing closer to a data source.

Data Centers: Although not traditionally considered “edge” environments, data centers may benefit from the disclosed PENN by reducing overall energy footprint associated with large-scale neural network computations, thereby decreasing operational costs and enhancing sustainability efforts.

Cloud Service Providers: As providers of computing resources and services, cloud service providers may leverage AI chips to enhance their offerings, such as accelerated computing services for AI workloads. The disclosed PENN framework may be used for secure deployment of AI chips within cloud infrastructure and provisioning of AI services to customers, ensuring data privacy and security standards are maintained.

Cybersecurity Solution Providers: Cybersecurity solution providers may use the disclosed PENN framework as a guideline for developing AI-enhanced cybersecurity solutions and/or as a market for products. The disclosed PENN may help ensure cybersecurity solutions that comply with the highest standards of security and are capable of protecting AI infrastructures from emerging threats.

Healthcare Organizations: Healthcare organizations using AI chips for diagnostics, patient care, research, and operational efficiency may benefit from the disclosed PENN framework by ensuring usage of AI technology that is ethical, secure, and in compliance with patient privacy laws and regulations. The disclosed PENN framework may also be used to facilitate safe integration of AI into medical devices and health information systems.

IoT Devices and Autonomous Vehicle Manufacturers: Manufacturers of IoT devices and autonomous vehicles may rely heavily on AI chips for processing capabilities. The disclosed PENN framework may provide standards for secure and responsible integration of AI chips into products to ensure that devices operate safely and reliably under various conditions.

Government and Defense Agencies: Agencies may use AI chips for a range of applications, from administrative efficiency and public services to national security and defense operations. The disclosed PENN framework may help ensure that the use of AI technology aligns with legal and ethical standards, protecting citizen data and national interests without compromising on security or integrity.

End Users and Consumers: While not directly involved in the development or deployment of AI chips, end users and consumers may be the ultimate recipients of AI-powered products and services. The disclosed PENN framework may ensure that products reaching the market are safe and secure and respect user privacy and rights.

Regulatory Bodies: Entities responsible for setting and enforcing standards may use the disclosed PENN framework to develop regulations that ensure the ethical use of AI, data protection, and cybersecurity by updating and enforcing compliance as technology evolves.

The following provides example benefits and/or technical improvements in accordance with some embodiments of the present disclosure:

Algorithm and Hardware Co-Optimization: In some embodiments, optimized algorithms for DNN training and inferencing may be implemented efficiently in hardware to achieve optimal performance, energy efficiency, and resource usage.

Resource Sharing in Neural Network: In some embodiments, a lookup technique based on LUT/SRAM/CAM may be used for resource sharing to implement neural networks. The disclosed sharing resources in neural networks may optimize the use of hardware resources, reduce energy consumption, and enhance computational efficiency.

Dynamic Switching between LUT, CAM, and SRAM: In some embodiments, a PENN framework may support dynamic switching between LUT, CAM, and SRAM structures for optimization of compute reuse.

Hierarchical Memory Operation: In some embodiments, computation reuse may be implemented using an automatic search of the most frequently encountered operand pair in a CAM/SRAM table associated at the cluster level, layer level, or global level. The search for the operand pair is available may be performed at the cluster level, if not, then search for availability may be performed at the layer level, and if not, then search may be performed at the global level. If the operand pair is found at any level, then fetch a multiplication or computation value from block memory corresponding to the operand pair, else perform multiplication operation in MAC unit.

Dynamic Layer Mapping: In some embodiments, the disclosed PENN hardware architecture may support the dynamic mapping of software neural network layers onto a fixed number of hardware layers, allowing the processing of an arbitrary number of layers without being constrained by hardware limitations.

Two level Optimization: In some embodiments, two levels of optimization may be applied by using pruning and quantization during a software design phase as well as at a hardware design phase to achieve significant optimization for energy and computation efficiency. Selective quantization may be performed for further optimization.

Neural Network Accelerator: In some embodiments, a PENN framework may be used to create DNN accelerators based on user specifications for on-device inference, training, or both. In some embodiments, a PENN framework may be used to implement a hardware-based, on-device-trained neural network accelerator that may be deployed at the network edge.

Inter-layer Communication Channel: In some embodiments, a PENN interlayer communication channel may facilitate efficient data transmission between hardware layers, ensuring seamless integration and processing.

On-Device Training and Active Personalization: In some embodiments, on-device training is disclosed for better performance and users' personal data privacy protection, which may be important for edge/mobile devices with limited computation and battery power. In some embodiments, on-device training is performed using local data, thereby preserving privacy by avoiding data transmission over wireless links. In some embodiments, on-device learning operates independently of an internet connection, saving bandwidth, reducing latency, and conserving energy by eliminating data uploads or model downloads. However, DNN models may often specify significant memory bandwidths and floating-point operations, particularly in embedded devices. The disclosed approach may provide energy efficient solutions, reduce memory demands, and/or improve training efficiency.

Adaptive Bit-Precision Optimization: In some embodiments, adaptive bit-precision optimization is adopted by dynamically adjusting bit precision in computations to optimize performance, energy efficiency, and resource use. The suitable precision is determined based on model complexity, data, and hardware.

Real-Time Energy Monitoring and Feedback Mechanism: In some embodiments, integrating real-time energy monitoring and feedback mechanisms within a PENN framework may provide immediate insights into energy consumption patterns. Operational parameters may be dynamically adjusted based on real-time data to enable proactive energy management.

Cross-Layer Optimization for Enhanced Data Locality and Reduced Memory Access: In some embodiments, a PENN may employ cross-layer optimization techniques to enhance data locality, minimizing the need for frequent memory access, which may be a significant contributor to energy consumption. By reorganizing data and computations to keep related operations within the same memory hierarchy level, a PENN may reduce the data movement across different memory levels, thereby lowering energy costs associated with memory access.

Battery Life Aware Adaptive Bit-Precision Modulation: In some embodiments, energy consumption and battery life may be a concern on remote edge devices. Adaptively lowering the bit-precision as the battery life is nearing to its end may extend the operational time of a remote/edge device. Lowering the bit-precision may affect overall device accuracy but may cause a trade-off between recording events at lower accuracy for long operational times vs. recording events at higher accuracy and precision for a relatively shorter device operation time. Users may also apply other policies in which a remote edge device is operating in very low bit-precision. Once the remote edge device receives a stimulus that is detectable at a specific bit-precision level, the remote edge device may wake up and increase the bit-precision to a permitted level for its battery level for a duration of an event. After the event has passed, the remote edge device may switch to its lower bit-precision energy conservation mode for relatively longer operational time.

Resource Sharing: In some embodiments, multiple software neurons in a PENN may be grouped to form a PENN hardware neuron, which includes shared resources where the values of computational units—such as adders, multipliers, and activation units—are pre-computed and stored in truth tables. This approach may ensure that all possible input combinations and their corresponding values are stored, utilizing LUTs for pre-computations. Additionally, computations may be stored within a SRAM-based architecture, and partial responses, such as top responses, can be retained in a Content Addressable Memory (CAM)-based architecture. Hierarchical architecture where the LUTs or part of the library of pre-computed values may be distributed across hierarchy of IoT architecture, much in the same way as the memory hierarchy in a processor system.

Pre-computation-based Implementation to Reinforcement Learning: In some embodiments, extending pre-computation-based implementation of LUTs in reinforcement learning (RL) applications may enhance the computational efficiency and scalability of such implementations. LUTs may provide quick data retrieval by storing pre-computed values, but they may face memory and scalability issues. By integrating RL, LUTs may be dynamically updated based on an agent's interactions and experiences, reducing memory overhead and allowing for adaptive learning. This hybrid approach may enable initial rapid decision-making through LUTs and continuous improvement and generalization through RL, leading to a more efficient and scalable solution for complex tasks. Based on the continuous learning on the previous LUT-based values, entries may be predicted during runtime.

Evolving Table (that Dynamically Evolves Over Time to Include New Set of Pre-Computed Values Based on the Input Patterns): In some embodiments, an evolving table is a feature of the PENN framework that dynamically updates over time to include new pre-computed values based on input patterns. The evolving table may learn by using evolving counters, which monitor a CAM table for frequently occurring values. By tracking these values, a system may predict the most common entries, learn patterns of frequent entries in the CAM table, and use a machine-learning model (which can either be in the cloud or can be in-sensor) to make predictions. The system may continually monitor actual values and penalizes incorrect predictions, prompting retraining and improved inference. This approach may reduce computation by predicting CAM table values beforehand, storing only the predicted entries.

Pre-Computation at Different Levels of Abstractions: In some embodiments, a PENN framework may be distributed across different levels of abstraction in a larger system, such as node/leaf level (e.g., edge of the network), data access point (e.g., part of a network referred to as the fog), and within the cloud.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation. It should be understood that the examples and embodiments in the Appendix are also for illustrative purposes and are non-limiting in nature. The contents of the Appendix are incorporated herein by reference in their entirety.

1. A system comprising:
a pre-compute storage memory comprising a plurality of pre-computed results that correspond to a neural network operation during inferencing or training, wherein the pre-compute storage memory is configured to provide the plurality of pre-computed results as output that is used in determining an activation of a next layer in a neural network;
a memory array configured to store a plurality of weight activation sets;
an address decoder configured to (i) generate an address in the pre-compute storage memory that matches an input operand, wherein the address corresponds to a weight activation set of the plurality of weight activation sets that matches the input operand and (ii) fetch a pre-computed result of the plurality of pre-computed results from the pre-compute storage memory based on the address.

2. The system of claim 1, wherein the memory array comprises (i) an activation memory configured to store one or more high-frequency input activations corresponding to the plurality of weight activation sets and (ii) a weight memory configured to store one or more weights corresponding to the one or more high-frequency input activations.

3. The system of claim 1, wherein the pre-compute storage memory comprises a content-addressable memory (CAM), a static random-access memory (SRAM), or a lookup table (LUT)-based structure.

4. An apparatus comprising:
a plurality of pre-computation-based energy-efficient neural network (PENN) neurons, wherein a PENN neuron comprises a multiply-accumulate (MAC) unit, a neuron finite state machine (FSM), and a neuron pre-compute storage memory;
a cluster computational unit configured to compute values for the plurality of PENN neurons;
a layer pre-compute storage memory configured to store a plurality of pre-computed results of a plurality of neural network operations; and
a layer FSM configured to utilize the plurality of pre-computed results during the plurality of neural network operations.

5. The apparatus of claim 4, wherein the neuron pre-compute storage memory or the layer pre-compute storage memory comprises a content-addressable memory (CAM), a static random-access memory (SRAM), or a lookup table (LUT).

6. The apparatus of claim 5, wherein the neuron pre-compute storage memory or the layer pre-compute storage memory is configured to store a plurality of pre-computed multiplication results for frequently occurring input patterns.

7. The apparatus of claim 6, wherein the neuron FSM is configured to retrieve the plurality of pre-computed multiplication results from the neuron pre-compute storage memory to bypass multiplication operations during neural network computations.

8. A method comprising:
receiving input data for a neural network operation on a neural network;
determining a pre-computed result corresponding to the input data is stored in a pre-compute storage memory;
retrieving the pre-computed result from the pre-compute storage memory; and
performing the neural network operation using the retrieved pre-computed result.

9. The method of claim 8, wherein the pre-compute storage memory comprises a content-addressable memory (CAM), a static random-access memory (SRAM), or a lookup table (LUT).

10. The method of claim 9, wherein the pre-computed result comprises a multiplication result for a frequently occurring input pattern corresponding to the neural network operation.

11. The method of claim 10, further comprising:
applying a pruning technique or a quantization technique to optimize the neural network operation.

12. The method of claim 11, wherein the pruning technique comprises removing a weight or an activation with low magnitude comprising minimal impact on performance of the neural network.

13. The method of claim 12, wherein the quantization technique comprises discretizing a range of weight or activation values that reduces bit representation of the range of weight or activation values.

14. The method of claim 13, further comprising:
dynamically reconfiguring a smallest unit of data in the pre-compute storage memory.

15. The method of claim 8, further comprising:
generating a frequency distribution of a plurality of operand pairs for a plurality of neural network operations; and
storing a set of one or more most frequently occurring operand pairs and a set of corresponding multiplication results in the pre-compute storage memory.

16. The method of claim 8, wherein (i) the neural network comprises a convolutional neural network (CNN) and (ii) the pre-computed result comprises a multiplication result for an input feature map and a filter weight.

17. The method of claim 8, wherein (i) the neural network comprises a recurrent neural network (RNN) and (ii) the pre-computed result comprises a multiplication result for a hidden state and a recurrent weight.

18. The method of claim 8 further comprising:
upscaling a data unit from the pre-compute storage memory to a byte-addressable format associated with communication with an external device.
